(19) United States
(12) Patent Application Publication
(10) Pub. No.: US 2008/0231780 A1
(43) Pub. Date: Sep. 25, 2008

(54) Low-absorptive diffuser sheet and film stacks for direct-lit backlighting

(75) Inventors: John F. Graf, Ballston Lake, NY (US); Dennis J. Coyle, Clifton Park, NY (US); Eugene Olczak, Pittsford, NY (US); Philip Peters, Mt. Vernon, IN (US); Masako Yamada, Saratoga Springs, NY (US)

Correspondence Address: FOLEY AND LARDNER LLP;SUITE 500, 3000 K STREET NW, WASHINGTON, DC, 20007, US

(73) Assignee: SABIC Innovative Plastics IP BV

(21) Appl. No.: 11/976,961

(22) Filed: Oct. 30, 2007

Related U.S. Application Data
(63) Continuation-in-part of application No. 11/723,891, filed on Mar. 22, 2007.

(51) Int. Cl. G02F 1/1335; F21V 5/00; G02B 5/02; B05D 5/06

(52) U.S. Cl. 349/112; 359/599; 362/246; 427/168

(57) ABSTRACT

There is provided an optical plate. The optical plate includes a supporting substrate and an optical diffuser film. The optical diffuser film has a density of light scattering particles to provide light diffusion. The optical diffuser film has a surface facing the supporting substrate, wherein a first portion of the surface facing the supporting substrate contacts the supporting substrate. There exists a gap between a second portion of the surface facing the supporting substrate and the supporting substrate, wherein the ratio of the area of the first portion to the second portion is less than 10%.

### RELATED APPLICATIONS

This application is a continuation-in-part application of U.S. application Ser. No. 11/723,891 filed on Mar. 22, 2007.

### BACKGROUND OF THE INVENTION

This invention relates to diffuser sheets, and display assemblies incorporating such diffuser sheets.

A backlight illuminates a liquid crystal (LC) based display panel to provide light distribution over the entire plane of the LC display (LCD) panel. Typical direct-lit LCD backlights consist of individual fluorescent lamps placed in a reflecting cavity to directly shine light upwards towards and through the LCD panel.

A typical direct-lit LCD backlight has a diffuser sheet to hide the individual lamps. The diffuser sheet is typically filled with light-scattering particles, has a transmission of only about 55% and a haze of over 99% to drastically scatter the light so that the individual lamps cannot be seen. On top of the diffuser sheet is a “bottom diffuser” that is typically a plastic film coated with spheres and a binder, which aids in hiding the bulbs, but also turns or collimates the light somewhat in the direction of the viewer. Often a prism film is arranged on the diffuser sheet, where the prism film has prisms running in a horizontal direction (direction parallel to the orientation of the lamps) to collimate the light strongly in the vertical direction (direction in the plane of the prism film and perpendicular to the horizontal direction). Typical applications for direct-lit backlights are in televisions, where it is acceptable to collimate the light vertically since viewers typically do not view from above or below the screen, while it is typical to not collimate horizontally since it is common to view the screen from side angles.

### SUMMARY OF THE INVENTION

One aspect of some embodiments of the present invention is to provide an optical diffuser sheet, and optical display assembly incorporating the sheet, that provides enough light-scattering to hide the individual light sources of a light provider from a viewer and provides relatively uniform diffuse light. Another aspect of some embodiments of the present invention is to provide an optical diffuser sheet, and optical display assembly incorporating the sheet, that directs light preferentially towards the viewer on-axis. Another aspect of the present invention provides an optical plate with a relatively thin optical diffuser film and supporting substrate or relatively thin optical diffuser film and frame.

According to one embodiment of the invention there is provided an optical plate. The optical plate comprises: a supporting substrate; and an optical diffuser film having a density of light scattering particles to provide light diffusion and having a surface facing the supporting substrate, wherein a first portion of the surface facing the supporting substrate contacts the supporting substrate and there exists a gap between a second portion of the surface facing the supporting substrate and the supporting substrate, wherein the ratio of the area of the first portion to the second portion is less than 10%.

According to another embodiment of the invention there is provided an optical display assembly. The optical display assembly comprises: a light provider comprising a plurality of light sources; and an optical plate comprising: a supporting substrate; and an optical diffuser film having a density of light scattering particles to provide light diffusion of light from the light provider and having a surface facing the supporting substrate, wherein a first portion of the surface facing the supporting substrate contacts the supporting substrate and there exists a gap between a second portion of the surface facing the supporting substrate and the supporting substrate, wherein the ratio of the area of the first portion to the second portion is less than 10%.

According to another embodiment of the invention there is provided an optical plate. The optical plate comprises: a supporting substrate; an optical diffuser film having a density of light scattering particles to provide light diffusion and having a surface facing the supporting substrate and a gap between the optical diffuser film and supporting substrate, the surface having a total area above the supporting substrate; and a plurality of pillar structures between and contacting both the optical diffuser film and the supporting substrate, the plurality of pillar structures contacting the optical diffuser film over a first area of the surface facing the supporting substrate, wherein the ratio of the first area to the total area is less than 10%.

According to another embodiment of the invention there is provided an optical display assembly. The optical display assembly comprises: a light provider comprising a plurality of light sources; and an optical plate comprising: a supporting substrate; an optical diffuser film having a density of light scattering particles to provide light diffusion of light from the light provider and having a surface facing the supporting substrate and a gap between the diffuser film and supporting substrate, the surface having a total area above the supporting substrate; and a plurality of pillar structures between and contacting both the optical diffuser film and the supporting substrate, the plurality of pillar structures contacting the optical diffuser film over a first area of the surface facing the supporting substrate, wherein the ratio of the first area to the total area is less than 10%.

According to another embodiment of the invention there is provided an optical assembly. The optical assembly comprises: a light provider comprising a plurality of light sources; an optical diffuser film over the light provider and arranged to receive light from the light provider, wherein a gap exists between the light provider and the optical diffuser film, the optical diffuser film having a density of light scattering particles to provide light diffusion.

According to another embodiment of the invention there is provided a method of forming an optical plate. The method comprises: spray coating an optical diffuser film on a supporting substrate, the optical diffuser film having a density of light scattering particles to provide light diffusion and having a surface facing the supporting substrate, wherein a first portion of the surface facing the supporting substrate contacts the supporting substrate and there exists a gap between a second portion of the surface facing the supporting substrate and the supporting substrate, wherein the ratio of the area of the first portion to the second portion is less than 10%.

### BRIEF DESCRIPTION OF THE DRAWINGS

FIG. 1 is a schematic perspective view of an optical display assembly with optical diffuser sheet according to an embodiment of the invention.

FIG. 2 is a perspective view of a diffuser sheet according to an embodiment of the invention.

FIG. 3 is an illustration of a light provider 12 with light sources 32 for explaining hiding power.

FIG. 4 is a perspective view of a diffuser sheet according to an embodiment of the invention.

FIG. 5 is a perspective view of a diffuser sheet with optical structures on both sides according to an embodiment of the invention.

FIG. 6 is a cross-section of a diffuser sheet with idealized optical structures.

FIG. 7 is a perspective of a diffuser sheet with optical structures having some random modulation in the lateral direction according to an embodiment of the invention.

FIG. 8 is a perspective of a diffuser sheet with optical structures having some random modulation in a direction perpendicular to the lateral direction according to an embodiment of the invention.

FIG. 9 is a cross sectional view illustrating a convex half cylinder surface texture of a diffuser sheet according to an embodiment of the invention.

FIG. 10A is a cross sectional view illustrating a convex sinusoidal surface texture of a diffuser sheet according to an embodiment of the invention.

FIG. 10B is a cross sectional view illustrating a concave half cylinder surface texture of a diffuser sheet according to an embodiment of the invention.

FIG. 11 is a schematic perspective view of an optical display assembly with optical diffuser sheet according to another embodiment of the invention.

FIG. 12 is a schematic perspective view of an optical display assembly with optical diffuser sheet according to another embodiment of the invention.

FIG. 13 is a schematic perspective view of an optical display assembly with optical diffuser sheet according to another embodiment of the invention.

FIG. 14 is a schematic perspective view of an optical display assembly with optical diffuser sheet according to another embodiment of the invention.

FIG. 15 is a schematic perspective view of an optical display assembly with optical diffuser sheet according to another embodiment of the invention.

FIG. 16 is a schematic perspective view of an optical display assembly with optical diffuser sheet according to another embodiment of the invention.

FIG. 17 is a schematic perspective view of an optical display assembly with optical diffuser sheet according to another embodiment of the invention.

FIG. 18 is a schematic perspective view of an optical display assembly with optical diffuser sheet according to another embodiment of the invention.

FIG. 19 is a schematic perspective view of an optical display assembly with optical diffuser sheet according to another embodiment of the invention.

FIG. 20 is a schematic perspective view of an optical display assembly with optical diffuser sheet according to another embodiment of the invention.

FIG. 21 is a graph illustrating luminance as a function of view angle for both vertical and horizontal views.

FIG. 22 is a schematic perspective view of an optical display assembly with optical diffuser sheet according to another embodiment of the invention.

FIG. 23 is a schematic perspective view of an optical display assembly with optical diffuser sheet according to another embodiment of the invention.

FIG. 24 is a schematic perspective view of an optical display assembly with optical diffuser sheet according to another embodiment of the invention.

FIG. 25 is a schematic perspective view of an optical display assembly with optical diffuser sheet according to another embodiment of the invention.

FIG. 26 is a graph illustrating luminance as a function of horizontal view angle for stacks of optical components with and without an optical diffuser sheet.

FIG. 27 is a schematic cross-sectional view of an optical plate with diffuser film and supporting substrate according to one embodiment of the invention.

FIG. 28 is a schematic cross-sectional view of an optical plate with diffuser film and supporting substrate according to another embodiment of the invention.

FIG. 29 is a schematic cross-sectional view of an optical plate with diffuser film and supporting substrate illustrating pillars with different shapes and composition.

FIG. 30 is a graph illustrating the absorbance as a function of the area covered for the different pillars of FIG. 29.

FIG. 31 is a side view of an optical assembly with relatively thin diffuser film and supporting frame according to another embodiment of the invention.

FIG. 32 is a top view of the optical assembly of FIG. 31.

FIG. 33 is a schematic cross-sectional view of an optical plate with diffuser film and supporting substrate according to another embodiment of the invention.

FIG. 34A is a cross sectional view illustrating a hemispherical surface texture of a diffuser sheet according to an embodiment of the invention.

FIG. 35A is a perspective view of the hemispherical surface texture of FIG. 34A.

FIG. 35 is a schematic cross-sectional view of an optical plate with diffuser film and supporting substrate according to another embodiment of the invention.

FIG. 36 is a schematic perspective view of an optical display assembly with optical plate according to another embodiment of the invention.

FIG. 37 is a schematic perspective view of an optical display assembly with optical plate according to another embodiment of the invention.

FIG. 38 is a schematic perspective view of an optical display assembly with optical plate according to another embodiment of the invention.

FIG. 39 is a schematic perspective view of an optical display assembly with optical plate according to another embodiment of the invention.

FIG. 40 is a schematic perspective view of an optical display assembly with optical plate according to another embodiment of the invention.

FIGS. 41A-41C are schematic side views of various optical diffuser films and supporting substrates for illustrating the optical effect of a gap.

### DETAILED DESCRIPTION OF THE PREFERRED EMBODIMENTS

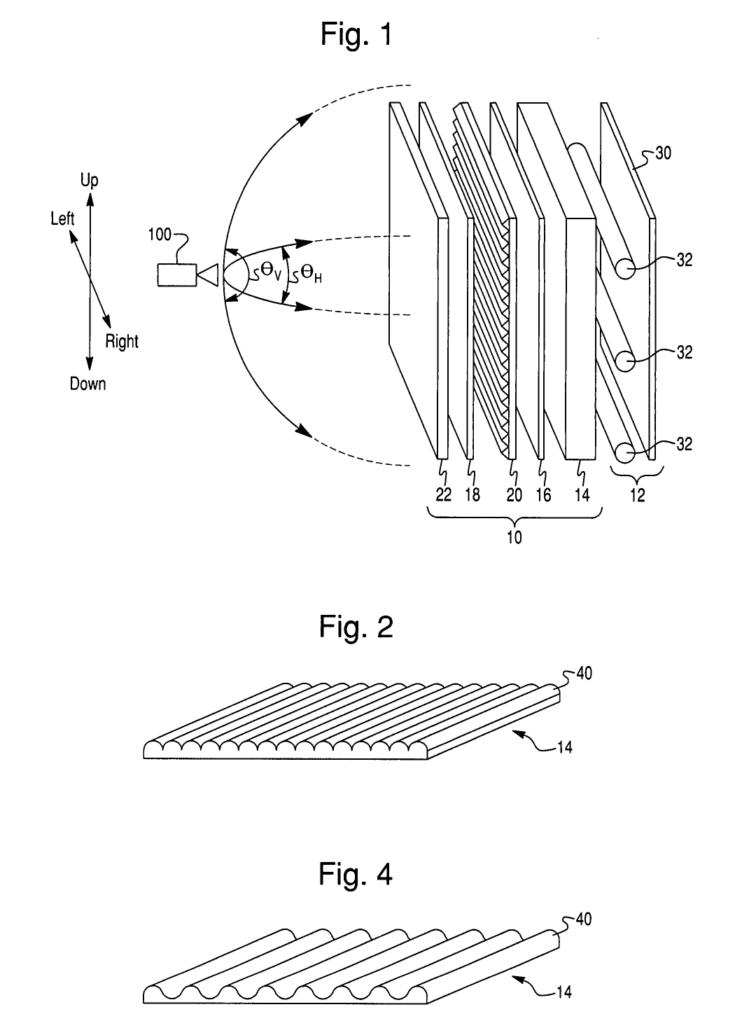

FIG. 1 is a schematic illustrating an embodiment of an optical display assembly 10. The optical display assembly includes a light provider 12, an optical diffuser sheet 14, optical films 16, 18, and 20, and liquid crystal 22.

The light provider 12 includes a reflector 30, and a number of light sources 32. The light sources may be, for example, lamps such as cold cathode florescent lamps (CCFLs). The light sources are oriented parallel to each other and along a horizontal direction from left-to-right as shown in FIG. 1. The up and down or vertical direction is a direction in the plane of the light sources 32, but perpendicular to the horizontal left-to-right direction. While FIG. 1 illustrates three light sources 32 for illustration purposes, in general, the number of light sources 32 will be much larger then three.

Prism film 20 has a number of prism structures generally parallel to each other and oriented along the horizontal direction. The prism film 20, may be, for example, composed of poly(ethylene terephthalate) having a texture coating with an array of prisms.

The diffuser films 16 and 18 have a density of light scattering particles to provide light diffusion and/or a rough surface to provide light diffusion. The diffuser films may be, for example, made of polycarbonate with 2 micron diameter particles composed of hydrolyzed poly(alkyl trialkoxysilanes) available under the trade name TOSPEARL™ from GE Silicones.

FIG. 1 also illustrates the geometry for determining the luminance as a function of zenith angle for both a horizontal view and a vertical view. A light detector 100 is oriented facing perpendicular to the plane of the light provider 12. In this position, the detector 100 may detect the on-axis luminance. The detector 100 may be rotated along an arc about an axis in the horizontal direction to determine the vertical view luminance. In this case, the detector 100 may be rotated about a vertical zenith angle θv and the luminance as a function of the vertical zenith angle θv may be obtained. The detector 100 may also be rotated along an arc about an axis in the vertical direction to determine the horizontal view luminance. In this case the detector may be rotated about a horizontal zenith angle θh and the luminance as a function of the horizontal zenith angle θh may be obtained.

The horizontal view luminance as a function of horizontal zenith angle θh provides an indication of the directional nature of the light from the optical display assembly, and thus the light directing properties for a horizontal view of the optical components in the optical display assembly. For example, if the horizontal view luminance as a function of horizontal zenith angle θh exhibits a narrow peak around a zero degree zenith (on axis), then the light for the horizontal view is well collimated. In a similar fashion, the vertical view luminance as a function of vertical zenith angle θv provides an indication of the light directing properties for a vertical view of the optical components in the optical display assembly.

FIG. 2 illustrates a diffuser sheet 14 according to one embodiment of the invention. The diffuser sheet 14 has a plurality of surface microstructures or optical structures 40 that are structured to provide both hiding power, such that the individual light sources 32 cannot be seen by an observer, and a desired directional output of light.

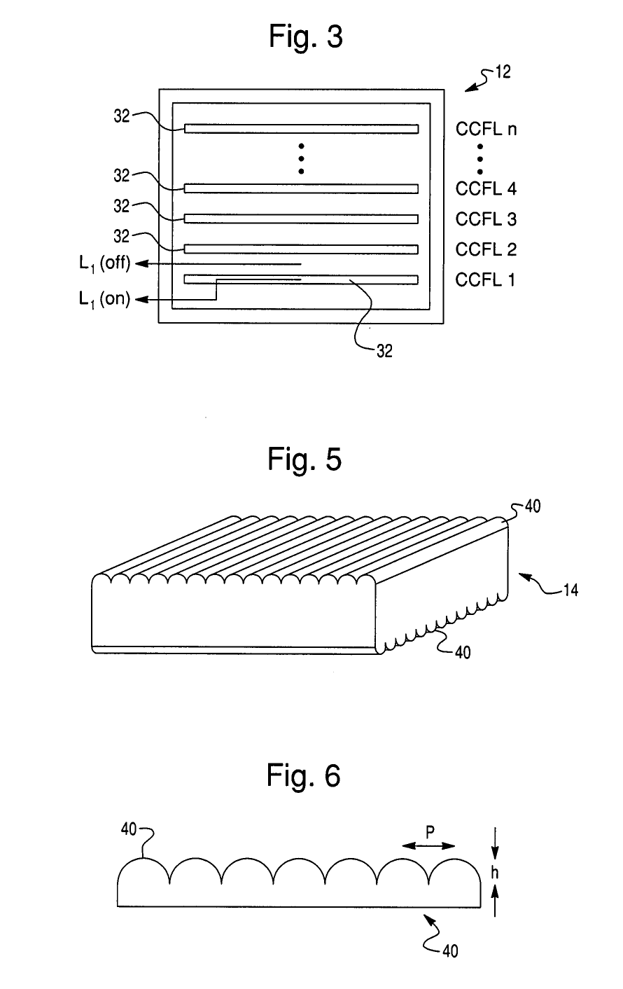

FIG. 3 is an illustration of a light provider 12 with light sources 32 (CCFLs) for explaining hiding power. The term “hiding power” as used herein refers to the ability of light diffusing films to mask the light and dark pattern produced by, for example, the light sources 32, such as the linear array of CCFLs shown in FIG. 3. Quantitatively, hiding power can be mathematically described by FIG. 3 and the following equation:

$$Hiding power ( \% ) = ( 1 - \frac{{\sum }_{i = 1}^{n - 1} {L}_{i} ( on )}{{\sum }_{j = 1}^{n - 1} {L}_{j} ( off )} ) \times 100$$

where Lᵢ(on) is the luminance directly above one of the lamps, and Lⱼ(off) is the luminance directly above a midpoint between lamp j and lamp j+1, and n is the number of lamps. FIG. 3 illustrates n lamps. The luminance is measured on the side of the diffusing film opposite to the light provider 12. The point between adjacent lamps is relatively darker in comparison to a point above a lamp. Thus, in general the Lⱼ(off) values will be less than the Lᵢ(on) values, and thus the summation of the Lᵢ(on) will be greater than the summation of the Lⱼ(off). If a light diffusing film perfectly hides the lamps, then the Lⱼ(off) values will be the same as the Lᵢ(on) values, and the hiding power has a value of 0%. In general the hiding power may have a positive or a negative value. Often the value of importance for the hiding power is the absolute value of hiding power, or absolute hiding power.

Returning to FIG. 2, preferably the diffuser sheet 14 has little or no light-scattering particles, as the diffusion function is performed by optical structures 40. Conventional diffuser sheets often use only light-scattering particles to provide a desired hiding power. Light scattered in such diffuser sheets with a high density of light scattering particles undergo multiple scattering events, meaning that a light ray sees an extremely long path traveling through such a sheet and thus a significant amount of light gets absorbed in the sheet. In a typical diffuser sheet, 10% of the light is absorbed per pass. If a prism film is placed above such a sheet, it recycles some of the light back down through the diffuser sheet, where it bounces off of the reflector and passes back up through the diffuser sheet, losing 10% on both passes. This greatly reduces efficiency of such recycling film stacks. Thus, preferably the diffuser sheet 14 has little or no light-scattering particles to perform diffusion function, where that function is instead performed by optical structures 40 resulting in less light absorption by the diffuser sheet 14.

FIG. 2 illustrates the optical structures 40 to be convex structures with a half cylinder cross-section. The optical structures 40, however, may have a number of different shapes. For example, FIG. 4 illustrates a diffuser sheet 14 where the optical structures 40 are convex structures with a sinusoidal wave cross-section. The optical structures 40 may also be concave structures such as concave structures with a half cylinder cross-section, or a sinusoidal wave cross-section. The optical structures 40 should be such, however, to provide both an optical diffusion function as well as an optical light direction function. Here diffusion can be considered any light spreading or lensing effect whether achieved through reflection (including total internal reflection), refraction, diffraction or any combination thereof. Also, since prismatic surfaces result in image splitting that modifies the hiding power they also provide a diffusion function as well as a light redirection function.

FIG. 5 illustrates an embodiment of the diffuser sheet 14 where both sides of the sheet have optical structures 40. The optical structures for both sides may have a number of different shapes in the same fashion as for embodiments where only one side of the diffuser sheet 14 contains optical structures 40. FIG. 5 shows an arrangement where optical structures 40 on opposing sides of the diffuser sheet 14 are arranged to run perpendicular to each other.

If the diffuser sheet is incorporated in a display assembly with other optical components having a regular structure, such as a prism film with regularly spaced prism structures, interference Moiré effects may results. These Moiré effects may be reduced by randomizing the idealized structure of the optical structures 40. Reducing Moiré effects by randomizing an idealized structure of an optical structure is disclosed, for example, in U.S. Pat. No. 6,862,141 to Eugene Olczak, issued on Mar. 1, 2005, which discloses modulating an idealized prism structure of an optical substrate from a nominal linear path in a lateral direction (direction perpendicular to the height) by applying a nonrandom, random (or pseudo random) amplitude and period texture. The disclosure of U.S. Pat. No. 6,862,141 is incorporated herein by reference in its entirety.

FIG. 6 illustrates a cross section of a diffuser sheet 14 with idealized optical structures 40 characterized by a peak height h, and pitch p (distance between optical structures). The shape and dimensions of the idealized structure 40 may be randomized such that a shape and dimensions of each optical structure represents a random modulation of a corresponding idealized structure. For example, the height h and/or the pitch p may be randomly varied. Also the variations may be applied as a constant bias per structure or may vary along the length of the structure over a range of wavelengths and amplitudes.

In general the height, pitch and wavelengths may be in a range between 100 nanometers and 10 millimeters. The cross section of each structure may be concave, convex, sinusoidal, or triangular (prismatic), for example. The cross section might also be a piecewise assembly of these geometries or any other useful shape including diffractive micro structures and nano structures. The size of the diffuser sheet and/or the display in which the diffuser sheet is used may be in the range of one millimeter by one millimeter to several meters by several meters. The thickness may vary between 12 microns and 25 millimeters. Each and every parameter may be held constant or varied as described above. Additionally the parameters may be designed to incorporate desirable ratios between parameters (for example the relative pitch of one structure to another or the relative pitch of one structure to the LCD pixel pitch).

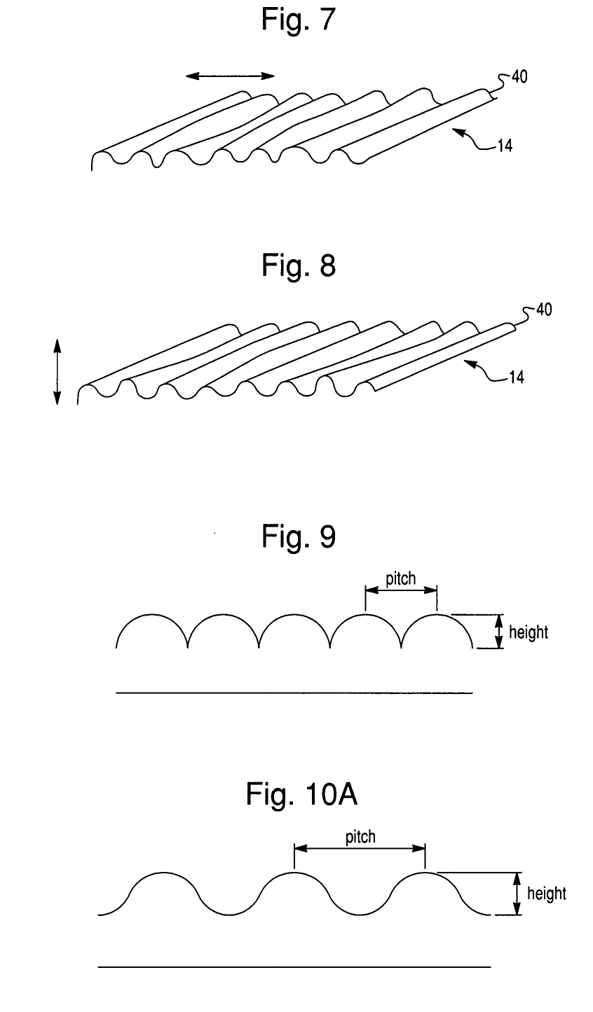

FIG. 7 illustrates a diffuser sheet 14 where the optical structures 40 have some random modulation in a lateral direction, such as in the pitch, while FIG. 8 illustrates a diffuser sheet 14 where the optical structures 40 have some random modulation in direction perpendicular to the lateral direction, such as in the height.

The random modulation in a direction perpendicular to the lateral direction, such as shown in FIG. 8, in addition to reducing Moiré effects, can also reduce optical coupling between the diffuser sheet 14 and any films arranged adjacent to the optical structures 40. This is so because the region of the diffuser sheet 14 which contacts the adjacent sheet is reduced, because the number of contact points between the diffuser sheet and the adjacent sheet is reduced by random modulation in a direction perpendicular to the lateral direction.

### DIFFUSER SHEET EXAMPLES

Table 1 illustrates examples of diffuser sheets according to embodiments of the invention along with two comparative examples DS and DS2. The values were calculated using an optical model validated through experimental results. The optical model is based on a geometric ray-tracing program that uses a Monte Carlo geometric ray tracing technique. Error bars on the result represent one standard deviation of the Monte Carlo error. The parameter values used by the optical model are for a typical 26″ direct-lit BLM. The optical model assumes that the bulbs and the reflector in the BLM absorb 6% of the light rays intersecting them and isotropically reflects the remaining 94%. The input parameters for the detector system include the spot size of 2 mm at the top of the film stack. The detector is located at 55 mm distance from the top of the film stack. For on-bulb measurements, the detector is positioned directly over top of the bulb when at zero degrees zenith. For the off-bulb measurements the detector is position between the bulbs. The rays (i.e. photons) fired by the Monte Carlo geometric ray tracing software program each have one unit of dimensionless energy. The software program figures out how much of the energy is absorbed and finally how much energy is emitted and in what direction. The dimensionless ray energy from the model is multiplied by a coefficient that converts it to luminance units of cd/m². The calculation results from the models were validated against experimental measurements.

TABLE 1
Diffuser sheets

| | | | Particle | Total | Total | | Sheet Only |
|---|---|---|---|---|---|---|---|
| Diffuser | Bottom | Top | Concentration | Transmission | Reflection | Absorption | Hiding |
| Sheet | Texture | Texture | (pph) | (%) | (%) | (%) | Power |
| 1. DS | Smooth | Smooth | 0.5 | 58.03 | 32.89 | 9.08 | −0.5 ± 0.6 |
| 2. DS2 | Smooth | Smooth | 0.125 | 79.12 | 15.6 | 5.28 | −28.7 ± 0.7 |
| 3. STDP-A | Smooth | Texture A | 0.125 | 60.88 | 32.44 | 6.68 | −8.2 ± 0.9 |
| 4. STDP-B | Smooth | Texture B | 0.125 | 64.21 | 28.77 | 7.02 | −6.3 ± 1.0 |
| 5. STDP-C | Smooth | Texture C | 0.125 | 70.53 | 22.78 | 6.69 | −6.4 ± 1.4 |
| 6. DTDP-A | Texture A | Texture A | 0 | 61.38 | 36.78 | 1.84 | −4.1 ± 1.0 |
| 7. DTDP-B | Texture B | Texture B | 0 | 71.34 | 26.77 | 1.89 | −2.6 ± 1.1 |

DS and DS2 are volumetric scattering diffuser sheets made of 2 mm thick polycarbonate. All diffuser sheets are 2 mm in thickness. Particle concentration is in parts per hundred (pph). The particles have a 2 micron diameter and are composed of hydrolyzed poly(alkyl trialkoxysilanes) available under the trade name TOSPEARL™ from GE Silicones. The based material for all the sheets is polycarbonate.

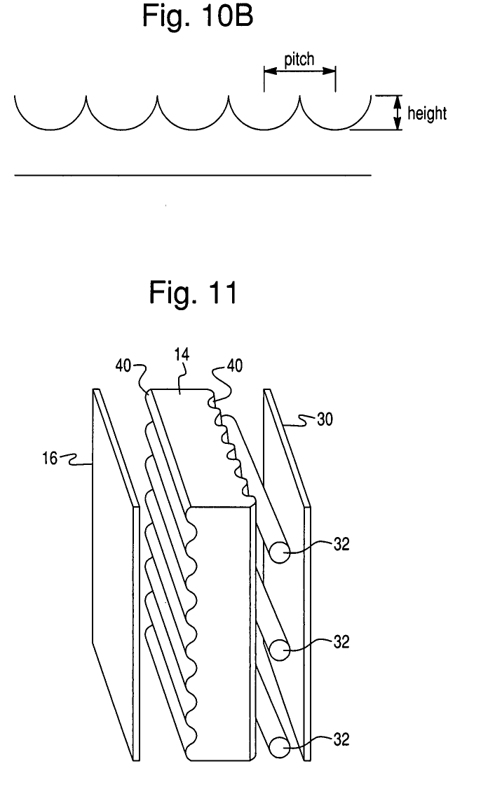

The bottom texture is the side of the diffuser sheet facing the light sources. The top texture is the side of the diffuser sheet facing the viewer (or detector). The three textures, labeled Texture A, Texture B, and Texture C are shown in FIGS. 9, 10A and 10B, respectively, and are a convex half cylinder, a sinusoidal wave, and a concave half cylinder texture, respectively. The pitch, distance between adjacent peaks or valleys, of the textures was between 5 and 200 microns. The aspect ratio, the ratio of the height of the features to the pitch, was between 0.2 and 1.0, and preferably between 0.4 and 0.5. The total transmission, reflection, and absorption are calculated using the validated optical model, and a geometric ray tracing software program.

STDP-A, STDP-B, and STDP-C, are diffuser sheets with one smooth side, and one textured side. The textured side for diffuser sheets STDP-A, STDP-B, and STDP-C have texture A, texture B and texture C, respectively, as those textures are shown in FIGS. 9, 10A, and 10B. DTDP-A and DTDP-B are diffuser sheets with textured sides on both sides of the diffuser sheet, where the optical structures on opposing sides of the diffuser sheet are arranged to run perpendicular to each other. Diffuser sheets DTDP-A and DTDP-B have texture A and texture B, respectively, as those textures are shown in FIGS. 9 and 10A.

Table 1 shows the reduction in absorption of the diffuser sheet for the single sided textures STDP-A, STDP-B and STDP-C (˜7%) as compared to a smooth surface diffuser sheet with a greater concentration of particles (˜9%). Table 1 also shows the reduction in absorption of the diffuser sheet for the double sided textures DTDP-A, DTDP-B (˜2%) as compared to a smooth surface diffuser sheet with a greater concentration of particles (˜9%).

Moreover, while the smooth diffuser plate with lower particle concentration, DS2, has an absorption less than ˜9%, it exhibits a significant loss in bulb hiding power for the smooth texture and at the equivalent of 0.125 pph particles as compared to the single texture diffuser sheets (texture A, B or C) with 0.125 pph particles.

### Optical Display Assembly Using Diffuser Sheet

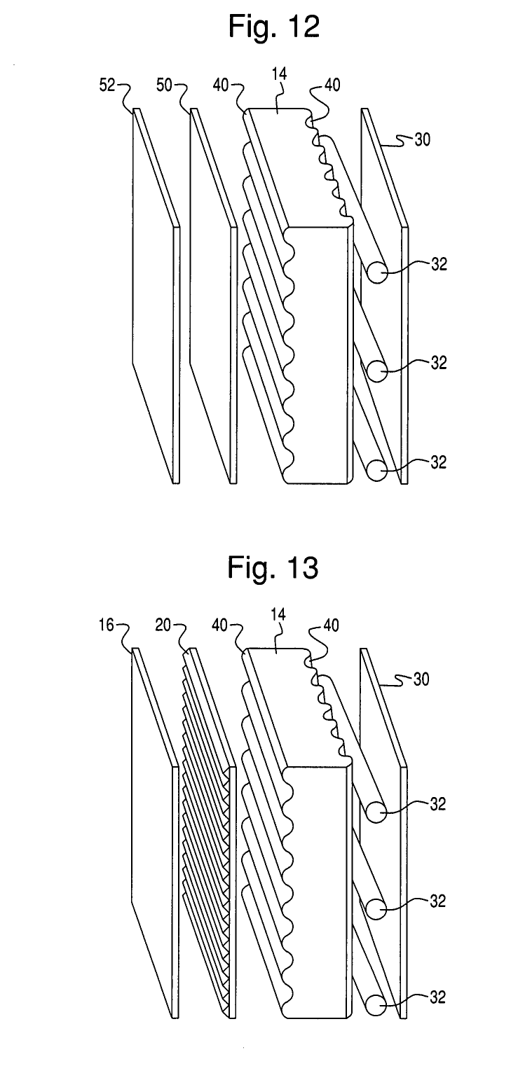

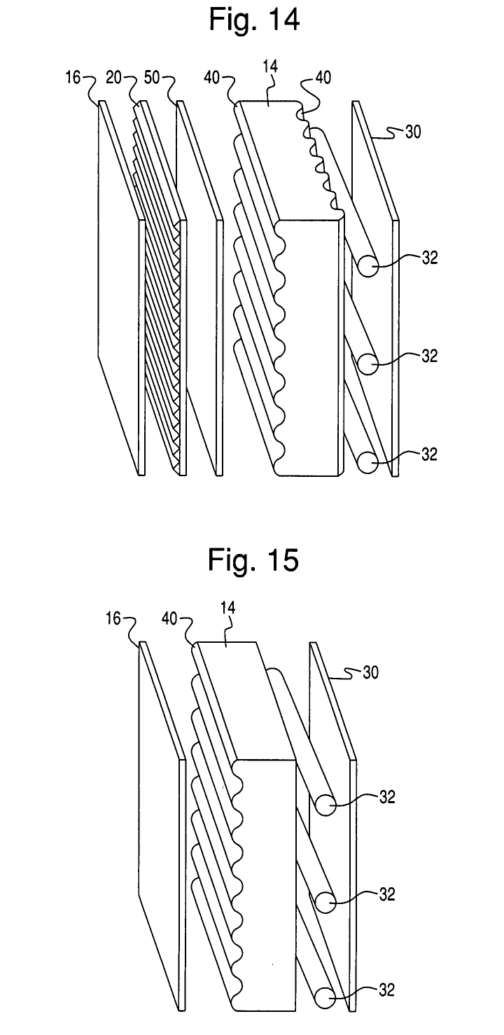

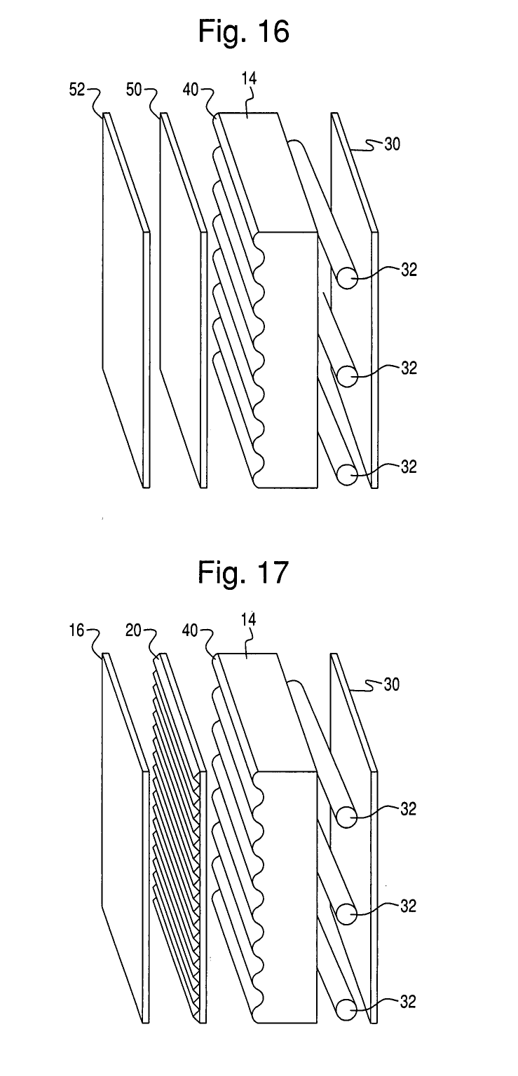

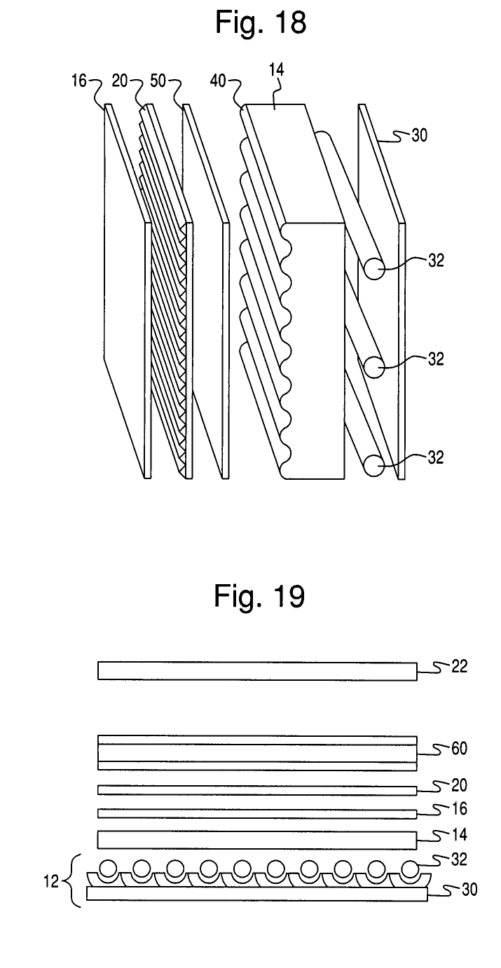

In addition to the optical display assembly illustrated in FIG. 1, the diffuser sheet 14 may be used in a number of different arrangements as illustrated hereafter. FIGS. 11-18 illustrate embodiments with various arrangements of the diffuser sheet 14, reflector 30, light sources 32, and variations of the optical films: diffuser film 16, diffuser film 18, light collimating diffuser film 50, and light collimating diffuser film 52. FIGS. 11-14 illustrate embodiments where the optical structures 40 are on both sides of the diffuser sheet 14, while FIGS. 15-18 illustrate embodiments where the optical structures 40 are on only one side of the diffuser sheet 14.

FIG. 19 illustrates an embodiment of the optical display assembly with diffuser sheet 14, including a recycling polarizer 60. The recycling polarizer is arranged above the diffuser sheet 14, diffuser film 16, and prism film 20, and below the liquid crystal 22. The reflective polarizer reflects some polarized light (e.g., light that is not in the correct direction to be received by the liquid crystal 22), while transmitting other polarized light. Other optical films that do not significantly depolarize light may be arranged between the recycling polarizer 60 and the liquid crystal. In some cases, it is possible for some textured films, such as prism films, to allow polarized light to be transmitted without significantly reducing the degree of light polarization even if they change the direction of polarization or transform the polarization state as defined for example by the Jones Matrix of the polarized component of optical field (The polarized and unpolarized components together comprise the more general Mueller Matrix). Thus it is possible to arrange the light recycling polarizer just below the LCD panel and those films that don't depolarize the light, but above the depolarizing diffuser films.

In some cases it may be desirable to tune the diffuser sheet, diffuser films or other components to provide an intentional transformation of the degree of polarization or polarization state to aid in more efficient polarization recycling or other display performance enhancements.

### Performance of Optical Display Assembly Including Diffuser Sheet

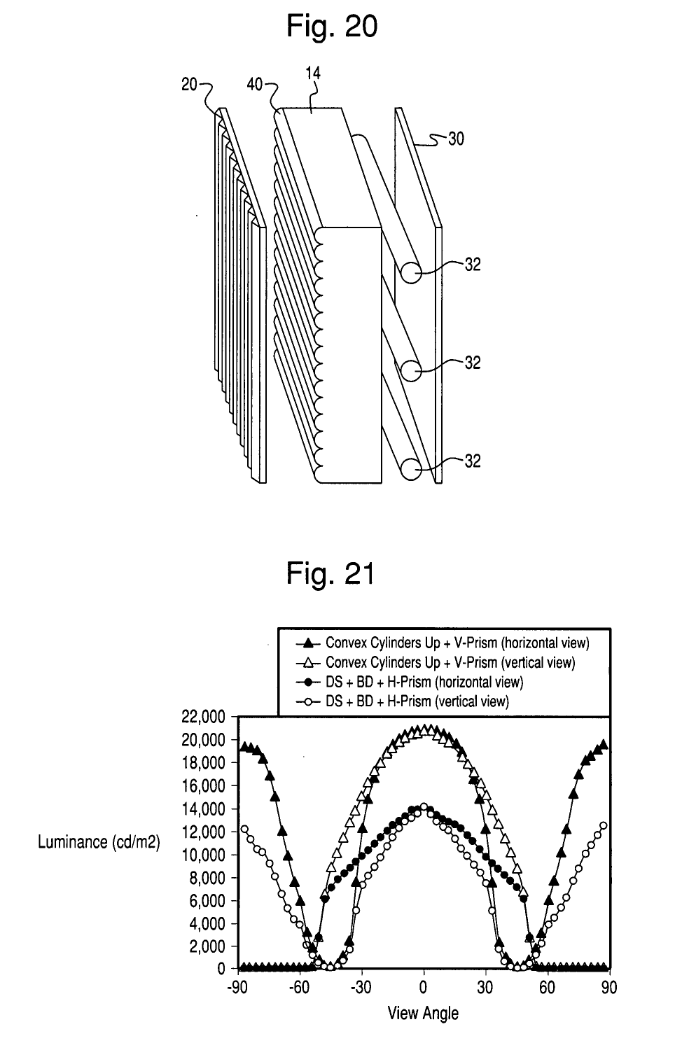

The performance of optical display assemblies including the diffuser sheet was calculated using the validated optical model. FIG. 20 illustrates one optical display assembly configuration for which the performance was calculated. The optical display assembly of FIG. 20 includes light provider 12 with CCFL light sources 32 and reflector 30, optical diffuser sheet 14 with optical structures 40, diffuser film 16 and prism film 20. The vertical view luminance was calculated as a function of vertical zenith angle, and the horizontal view luminance was calculated as a function of horizontal zenith angle for the arrangement shown in FIG. 20.

The results of the calculation are shown in FIG. 21. In addition to the horizontal view luminance and vertical view luminance for the display assembly shown in FIG. 20, FIG. 21 also shows horizontal view luminance and vertical view luminance for the case where an optical diffuser film 61 is added to the assembly. As can be seen, the configuration including the diffuser sheet 14 provides improved on-axis luminance. Note however the horizontal view is more narrow than the vertical view. If the light bulbs were oriented in a vertical direction rather than the horizontal, this device would then have a broader horizontal view.

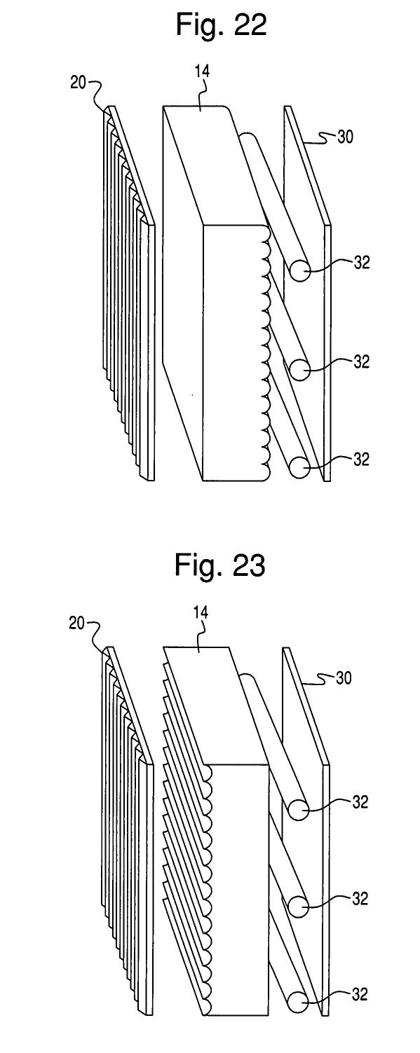

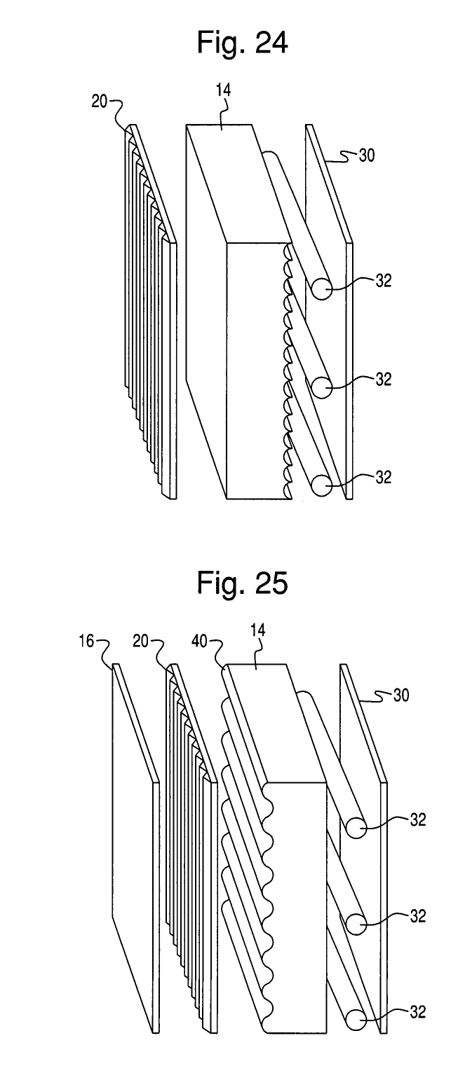

FIG. 20 illustrates a configuration where the optical diffuser sheet 14 has optical structures 40 on only one side, where the optical structures 40 are convex half cylinder structures arranged on the side opposite the CCFL light sources 32. The vertical and horizontal view luminance as a function of zenith angle was also calculated for the optical display assembly configurations as shown in FIGS. 22-24. In the FIG. 22, the optical structures 40 are convex half cylinder structures arranged on the side facing the CCFL light sources 32. In the FIG. 23, the optical structures 40 are concave half cylinder structures arranged on the side facing the CCFL light sources 32. In the FIG. 24, the optical structures 40 are concave half cylinder structures arranged on the side opposite the CCFL light sources 32.

FIG. 25 illustrates another configuration where the diffuser film 16 is arranged above the prism film 20, and the optical structures 40 are convex sinusoidal wave structures arranged on the side opposite the CCFL light sources 32. In the configuration of FIG. 25, the optical structures 40 are arranged in the same direction as the CCFL light sources 32 (horizontal direction), and the prisms of the prism film are arranged in a direction perpendicular (vertical direction) to the direction of the CCFL light sources 32.

The optical diffuser sheets 14 in FIGS. 20 and 22-25 do not have any light scattering particles, and are textured polycarbonate films.

Table 2 lists the luminance, and full width half maxima (FWHM) of both the horizontal view luminance and vertical view luminance of the arrangements of FIGS. 20 and 22-25, where FIG. 20 is convex cylinders up, FIG. 22 is convex cylinders down, FIG. 23 is concave cylinders down, FIG. 24 is concave cylinders up, and FIG. 25 is sinusoidal wave. The orientation of the optical structures 40 are in a horizontal direction, parallel to the orientation of the CCFL light sources 32. The prisms are vertical in orientation for FIGS. 20, 22, 23, 24 and 25. The diffuser film 16 in FIG. 25 has 95% transmission haze.

TABLE 2
Performance of optical display assembly configurations

| | | | Vertical | Bulb |
|---|---|---|---|---|
| | | Horizontal View | View | Hiding |
| Film Stack Description | Luminance (cd/m²) | (FWHM) | (FWHM) | Power % |
| 8. convex cylinders up | 21,011 ± 96 | 61.1 | 82.4 | 1.6 ± 0.6 |
| 9. convex cylinders down | 16,215 ± 165 | 64.3 | 98.4 | −4.6 ± 1.4 |
| 10. concave cylinders down | 16,391 ± 333 | 63.1 | 97.7 | −9.9 ± 2.9 |
| 11. concave cylinders up | 20,130 ± 409 | 60.8 | 97.2 | −0.5 ± 2.9 |
| 12. sinusoidal wave | 17,621 ± 253 | 58.2 | 71.4 | −0.0 ± 2.0 |

The results are shown in Table 2. The luminance shown is the on-axis luminance. Also shown in Table 2 is the full width half maxima for both the horizontal view and the vertical view.

TABLE 3
Performance of Single and Double Textured Diffuser Plates

| | | Horizontal | Vertical | |
|---|---|---|---|---|
| | | View | View | Bulb Hiding |
| Film Stack Description | Luminance (cd/m²) | (FWHM) | (FWHM) | Power % |
| 13. STDP-A | 9,638 ± 63 | 139.2 | 90.1 | −8.2 ± 0.9 |
| 14. STDP-B | 9,541 ± 66 | 139 | 93.8 | −6.3 ± 1.0 |
| 15. STDP-C | 9,046 ± 87 | 141.3 | 133.1 | −6.4 ± 1.4 |
| 16. STDP-B + BD | 11,585 ± 89 | 79.4 | 77.8 | −3.0 ± 1.1 |
| 17. STDP-C + BD | 11,249 ± 126 | 80.5 | 81.0 | −3.2 ± 1.6 |
| 18. STDP-B + BD + BD | 12,727 ± 98 | 67.4 | 67.4 | −1.0 ± 1.1 |
| 19. STDP-C + BD + BD | 12,566 ± 135 | 69.1 | 68.6 | −1.5 ± 1.5 |
| 20. STDP-B + Prism | 14,509 ± 132 | 96.4 | 63.3 | 1.5 ± 1.3 |
| 21. STDP-C + Prism | 13,505 ± 127 | 98.1 | 66.4 | 0.8 ± 1.3 |
| 22. STDP-B + BD + Prism | 14,729 ± 92 | 88.3 | 60.7 | 1.2 ± 0.9 |
| 23. STDP-C + BD + Prism | 14,737 ± 97 | 88.9 | 60.4 | −0.1 ± 0.9 |
| 24. DTDP-A | 10,051 ± 72 | 159.4 | 91.7 | −4.1 ± 1.0 |
| 25. DTDP-B | 9,766 ± 79 | 159.1 | 85.8 | −2.6 ± 1.1 |
| 26. DTDP-A + BD | 13,627 ± 196 | 85.4 | 72.7 | −1.5 ± 2.0 |
| 27. DTDP-B + BD | 12,571 ± 136 | 85.8 | 77.1 | −0.9 ± 1.5 |
| 28. DTDP-A + BD + BD | 16,405 ± 236 | 70.4 | 66.6 | 0.1 ± 2.0 |
| 29. DTDP-B + BD + BD | 15309 ± 116 | 71.0 | 67.8 | −2.6 ± 1.1 |
| 30. DTDP-A + Prism | 17,524 ± 252 | 97.8 | 62.6 | 1.4 ± 2.0 |
| 31. DTDP-B + Prism | 17,690 ± 147 | 97 | 63 | −4.3 ± 1.2 |
| 32. DTDP-A + BD + Prism | 19,898 ± 286 | 91 | 61.7 | 0.6 ± 2.0 |
| 33. DTDP-B + BD + Prism | 19,276 ± 165 | 91.9 | 61.4 | 1.0 ± 1.2 |

The film stack description in Table 3 lists the components of the assembly in order from the component just above the CCFL light sources 32 to the component at the top of the stack. STDP-A, STDP-B, STDP-C, are diffuser sheets with one smooth side, and one textured side. The textured side for diffuser sheets STDP-A, STDP-B, STDP-C have texture A, texture B and texture C, respectively, as those textures are shown in FIGS. 9, 10A, and 10B, respectively. DTDP-A and DTDP-B are diffuser sheets with textured sides on both sides of the diffuser sheet. Diffuser sheets DTDP-A and DTDP-B have texture A and texture B, respectively, as those textures are shown in FIGS. 9 and 10A. BD is a light collimating diffuser film composed of 0.125 mm thick poly(ethylene terephthalate) with micro lens texture on a side facing viewer (detector), i.e., on a side away from the light provider. Prism is a horizontally oriented (prisms are parallel to the CCFL light sources) prism film composed of 0.125 mm thick poly(ethylene terephthalate) having a texture coating with an array of straight prisms having a 50 micron pitch and 25 micron height.

The luminance shown in Table 3 is the on-axis luminance. Also shown in Table 3 is the full width half maxima for both the horizontal view and the vertical view, and the bulb hiding power. As can be seen from the results in Table 3, the diffuser sheets provide good hiding power, and light collimation for the vertical view, as well as good on-axis luminance.

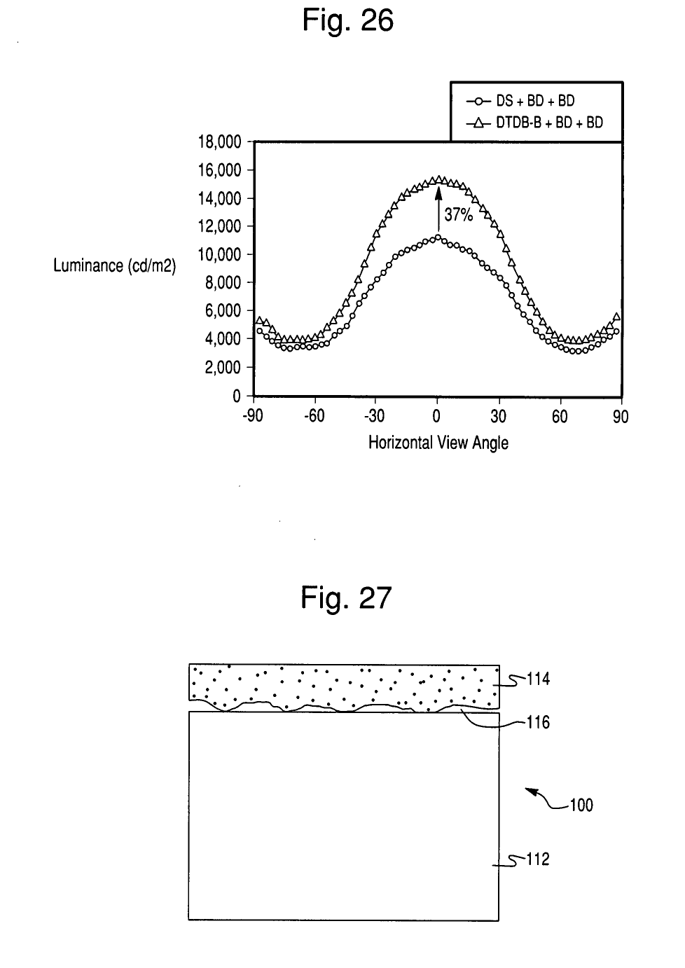

FIG. 26 provides a comparison of the luminance as a function of the horizontal zenith angle for a stack of optical components, in order, of DS+BD+BD with a stack of DTDP-B+BD+BD, where the components DS, BD and DTDP-B are as defined above. As can be seen there is a 37% increase in the on-axis luminance for the stack with the diffuser sheet DTDP-B, as compared to the one with the diffuser film DS.

As described above, the diffuser sheet can be used with diffuser films and/or prismatic films to provide various output distributions of light. These embodiments can increase the total output of light by more than 10%. On-axis luminance may be increased by 10-100%, depending on the specific combinations of microstructures and films. This enables a variety of designs to meet specific light-output requirements of a given display model, all of which are much brighter than conventional designs.

The light management film stacks for direct-lit display backlighting described above offer improved luminous efficiency. An important component is a low-absorption diffuser sheet, which can be used with diffuser films, prismatic films, or combinations thereof, that offers hiding power comparable to conventional diffuser sheets but higher on-axis luminance, improved luminance over wider view angles, improved total light throughput, and in some embodiments fewer optical components.

Small amounts of light-scattering particles could be added to the diffuser sheet to improve hiding power, depending on the design objectives for a specific backlight.

### Thin Low-Absorptive Diffuser Film With Optical Gap

According to another embodiment of the invention, an optical plate is provided, where the necessary hiding power is achieved by increasing the concentration of scattering particles in a relatively thin low-absorptive diffuser, and where an optical gap exists between the film and an underlying supporting substrate or between the film and a light provider with a supporting frame. The optical gap reduces optical coupling between the diffuser film and supporting substrate or light provider. Reducing the optical coupling between the diffuser film and supporting substrate reduces the effective pathlength of light that travels through the substrate with a corresponding reduction in the amount of light being absorbed by the supporting substrate.

FIG. 27 illustrates an embodiment of an optical plate 100 including an optical diffuser film 114 and a supporting substrate 112. Preferably, the optical diffuser film 114 is a relatively thin low absorption diffuser film. The supporting substrate 112 preferably has a low absorption, and low light scattering. The supporting substrate 112 functions to provide structural stiffness and support for the optical diffuser film 114. The supporting substrate 112 could be made of, for example, polycarbonate, glass, polyacrylates, polystyrene, or other optically clear materials. Preferably, the supporting substrate 112 is made of a material with low yellowness index and no absorbing dyes. Preferably, the supporting substrate 112 has an absorption of less than 1.5%. In addition, the supporting substrate 112 may have a texture to reduce its reflection and increase its transmission.

The optical diffuser film 114 may be formed on a supporting substrate 112 by any appropriate method. For example, the optical diffuser film 114 may be formed by extruding a film composed of an optically clear thermoplastic or glass with scattering particles. The extrusion process can use rollers to apply a rough texture on the diffuser film 114 to minimize the contact when the diffuser film 114 is placed on top of the supporting substrate 112. Alternative ways to form the diffuser film 114 include solvent casting, compression molding, spray coating a thin base film with particles and a carrier medium, UV curing a coating composed of particles and a carrier medium cast on a thin base film. The supporting substrate 112 can be formed using an extrusion sheet line, injection molding, or a compression molding process. The optical diffuser film 114 can be placed on top of the supporting substrate 112.

Furthmore, the optical diffuser film 114 can be physically attached to the supporting substrate 112 by any appropriate method. For example, an adhesive can be sprayed at point locations on either the supporting substrate 112 or the optical diffuser film 114 followed by laminating the optical diffuser film 114 to the supporting substrate. By controlling the size of the sprayed point dimensions and the number and location of spray points, one can control the contact area, binding strength, and visual quality. This can be accomplished using current ink jet technology. Furthermore, one can select an adhesive that has a refractive index and absorption coefficient so that it matches the either optical diffuser film or supporting substrate. Scattering particles may be added to the adhesive prior to spraying to introduce scattering within the adhesive.

In embodiments where pillars are disposed between the optical diffuser film 114 and the supporting substrate 112, one method of attachment would require that pillars be generated on the optical diffuser film 114 and/or the supporting substrate 112 so that they stick out of the plane of the film or substrate. The pillars could be generated using a film or sheet extrusion process by using a roller tooled with pillar cavities. The pillars could also be generated by an embossing process that uses a tool with the pillar cavities. The shape, size, depth, location, and frequency of the pillar cavities could be controlled in the tool. The supporting substrate 112 or the optical diffuser film 114 could then be laminated together by melt adhesion at the tips of the pillars. The adhesion process would lead to contact points only at the locations of the pillars thus controlling the contact area. The pillars could be made to include scattering particles by generating the pillars on the optical diffuser film 114 or could be made to be clear by generating the pillars on the supporting substrate 112.

The optical diffuser film 114 may be formed of, for example, polycarbonate with scattering particles. The scattering particles may be, for example, 2 micron diameter hydrolyzed poly(alkyl trialkoxysilanes) available under the trade name TOSPEARL™ from GE Silicones. The optical diffuser film may be made using other optically clear materials filled with other types and sizes of scattering particles. Preferably, the optical diffuser film 114 is made of a material having a low yellowness index and no absorbing dyes. Preferably, the optical diffuser film 114 has a relatively small thickness. Table 4 compares calculated optical properties of diffuser films having various thicknesses and scattering particle concentrations. The total number of scattering particles is the same for each of the four sample diffuser films in Table 4, but as the thickness of the sample film decreases, the concentration of the scattering particles is increased in a corresponding amount. The diffuser films are of optical quality polycarbonate with scattering particles composed of 2 micron TOSPEARL™ particles.

The decreased absorption in the thinner diffuser films is due to the scattered light traveling a shorter distance through the polycarbonate thus leading to a lower amount being absorbed by the polycarbonate. The increase in the concentration of the scattering particles with a thinner diffuser film maintains transmission haze and thus the hiding power of the plate. As can be seen from Table 4, the thinnest film of 0.125 mm provided a transmission haze as high as the other three films, while at the same time having the lowest total absorption.

TABLE 4
Calculated optical properties of diffuser films of various thicknesses.

| | Scattering | | | | |
|---|---|---|---|---|---|
| Diffuser film | Particle | | | | |
| Thickness | Weight % | Total % | Total % | Total % | Transmission |
| (mm) | Concentration | Reflection | Transmission | Absorption | Haze (%) |
| 2 | 0.5 | 32.9 | 57.9 | 9.2 | 99.5 |
| 1 | 1 | 35.0 | 60.2 | 4.8 | 99.5 |
| 0.5 | 2 | 36.0 | 61.5 | 2.5 | 99.5 |
| 0.25 | 4 | 36.7 | 62.1 | 1.2 | 99.5 |
| 0.125 | 8 | 36.9 | 62.5 | 0.6 | 99.5 |

The luminance of three samples in various configurations was also determined to compare the optical properties of a relatively thick diffuser film sample, relatively thin diffuser film sample, and relatively thin diffuser film supported by a clear supporting substrate. Sample A was a 1.4 mm thick polycarbonate diffuser film with 0.5% by weight TOSPEARL™. Sample B was a relatively thin diffuser film of 0.46 mm thick polycarbonate with 4% by weight TOSPEARL™. Sample C had two parts, a first part with a thin diffuser film made of 0.46 mm thick polycarbonate with 4% by weight TOSPEARL™, and a second part of an optically clear substrate made of 1.57 mm thick quartz glass supporting the first part. The 1.4 mm thick and 0.46 mm thick polycarbonate diffuser films were made by a compression molding process. The luminance measurements were made using a Microvision detector with the samples in a Westinghouse 19″ direct lit backlight module as a light source. For sample C, the quartz glass was arranged on the bottom closest to the light source with the thin diffuser film on top closest to the detector.

Measurements were taken on the three samples in five different configurations. Configuration #1 was the sample by itself. Configurations #2, #3, and #4 were with the sample and one, two, and three micro lens diffuser films, respectively, on top of the sample. Configuration #5 was the sample with one micro lens diffuser film and one straight 90-degree prism film on top closest to the detector.

Table 5 below illustrates the luminance for samples A to C in each of the five configurations #1 to #5. The measurements show an improvement in luminance for sample B and sample C over the thicker diffuser film sample A. The % gain in the luminance for sample B and sample C relative to the thicker diffuser film sample A increases with the number of light collimating micro lens diffuser films in the film stack. The configuration with the prism film, which strongly collimates light, shows the greatest gain in the luminance for samples B and C relative to the thicker diffuser film sample A. For example, samples B and C in configuration #5 have a respective. 18.4% and 13.5% gain in luminance relative to sample A for configuration #5.

TABLE 5
Luminance measurements (Cd/m²)

| | Sample A | Sample B | Sample C |
|---|---|---|---|
| | 1.4 mm thick | 0.46 mm thick | Quartz Glass |
| | polycarbonate | polycarbonate | Plate + 0.46 mm |
| | with 0.5% by | with 4% by | thick polycarbonate with |
| | weight | weight | 4% by weight |
| | TOSPEARL(™) | TOSPEARL(™) | TOSPEARL(™) |
| Film Stack | scattering | scattering | scattering |
| Configurations | particles | particles | particles |
| Configuration #1 | 6,167 | 6,263 | 5,898 |
| Sample Only | | | |
| Configuration #2 | 7,222 | 7,841 | 7,429 |
| Sample with 1 micro | | | |
| lens diffuser film | | | |
| Configuration #3 | 7,619 | 8,667 | 8,260 |
| Sample with 2 micro | | | |
| lens diffuser film | | | |
| Configuration #4 | 7,418 | 8,704 | 8,337 |
| Sample with 3 micro | | | |
| lens diffuser film | | | |
| Configuration #5 | 9,200 | 10,895 | 10,438 |
| Sample with 1 micro | | | |
| lens diffuser film and 1 | | | |
| prism film | | | |

Referring again to FIG. 27, the optical plate 100 has an optical gap 116 between the optical diffuser film 114 and the supporting substrate 112. The optical gap 116 functions to reduce optical coupling between the optical diffuser film 114 and the supporting substrate 112 and to reduce the amount of high angle light traveling through the relatively thick supporting substrate increasing the effective pathlength and the amount of light absorption in the supporting subtraste 112. In this regard, the optical gap 116 is a gas, such as air, or vacuum, and thus has a refractive index which is much lower than the optical diffuser film 114 and the supporting substrate 112.

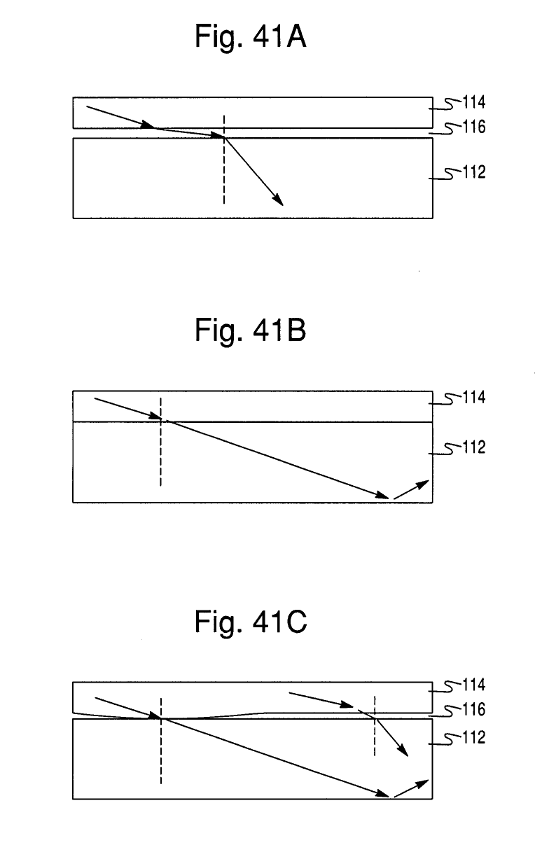

FIGS. 41A-41C are schematics for explaining the effect of the air gap, where FIG. 41A illustrates an air gap but no contact points between the substrate 112 and the diffuser film 114. FIG. 41B illustrates no air gap, and FIG. 41C illustrates an air gap with some contact points between the substrate 112 and the diffuser film 114. When an air gap is present between the diffuser film and the supporting substrate, light that enters the supporting substrate is refracted according to Snell's Law. For a supporting substrate with a smooth surface (See FIG. 41A), the highest angle that can be achieved is the supporting substrate's critical angle defined by Snell's Law and the refractive index. Since the scattering within the supporting substrate is minimal, the majority of light will travel through the supporting substrate below the critical angle. When no air gap is present between the diffuser film and the supporting substrate (See FIG. 41B), light within the diffuser film can exit and enter the supporting substrate at angles much higher than the critical angle. This increases the effective pathlength through the substrate leading to increased absorption. Furthermore, light above the critical angle will undergo a total internal reflection at the opposite surface of the supporting substrate similar to that observed in a light pipe.

Referring again to FIG. 27, the optical diffuser film 114 contacts the supporting substrate 112 over certain portions of the surface of the optical diffuser film 114 facing the supporting substrate 112, but not over other portions of the surface of the optical diffuser film 114 facing the supporting substrate 112. In general, a first portion of the surface of the optical diffuser film 114 facing the supporting substrate 112 contacts the supporting substrate 112. The optical gap 116 is between a second portion of the surface of the optical diffuser film 114 facing the supporting substrate and the supporting substrate 112.

In order to reduce the optical coupling between the optical diffuser film 114 and the supporting substrate 112, and to reduce the amount of high angle light traveling through the relatively thick supporting substrate layer, it is preferable that the ratio of the area of the first portion to the second portion is less than 10%. More preferably the ratio of the area of the first portion to the second portion is less than 3%. Most preferably the ratio of the area of the first portion to the second portion is less than 1%.

It is also preferable that the optical plate 100 have a low absorption and absolute hiding power. Preferably the optical plate 100 when illuminated is characterized by an absorption of less than 10% and an absolute hiding power of less than 10%. More preferably the optical plate 100 when illuminated is characterized by an absorption of less than 7% and an absolute hiding power of less than 7%. Most preferably the optical plate 100 when illuminated is characterized by an absorption of less than 4% and an absolute hiding power of less than 4%.

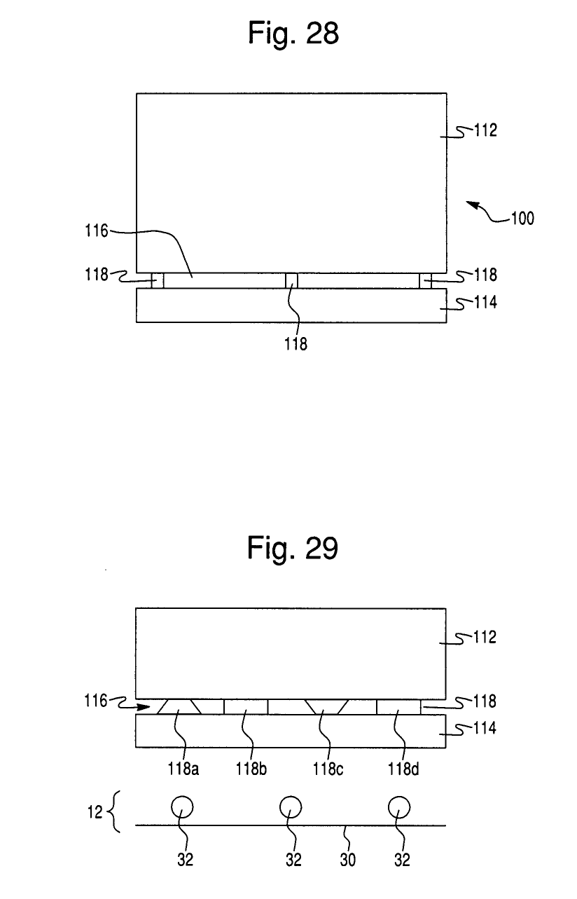

FIG. 28 illustrates another embodiment of the optical plate 100. As in the embodiment shown in FIG. 27, there is a gap 116 of air or vacuum between the optical diffuser film 114 and the supporting substrate 112. In the embodiment as shown in FIG. 28, however, the optical plate includes a plurality of pillar structures 118 between and contacting both the optical diffuser film 114 and the supporting substrate 112. The plurality of pillar structures 118 contact the optical diffuser film 114 over a first area of the surface of the optical diffuser film facing the supporting substrate 112. In order to reduce the optical coupling between the optical diffuser film 114 and the supporting substrate 112, the ratio of the first area to the total area of the surface of the optical diffuser film facing the supporting substrate 112 is preferably less than 10%. The preferable values of the supporting substrate absorption, the optical plate absorption, and the optical plate hiding power are the same as for the embodiment of FIG. 27. The pillar structure 118 may be formed of the same material as the optical diffuser film 114, for example.

The particular thicknesses of the supporting substrate 112 and optical diffuser film 114 will depend on the application, although in general the supporting substrate 112 is relatively thick as compared to the optical diffuser film 114. Preferably the thickness of the optical diffuser film 114 is less than 1 mm, more preferably less than 0.3 mm. As an example, the thickness of the optical diffuser film 114 and the supporting substrate 112 may be about 0.25 mm and about 1.75 mm, respectively. The thickness of the supporting substrate 112 should be sufficient to provide mechanical support and stiffness for the particular application, such as for large area displays. Preferably, the thickness of the supporting substrate 112 is between 0.5 to 10 mm, and more preferably between 1 and 2 mm.

The thickness of the optical gap 116 should be sufficient for its optical functionality. Preferably the thickness of the optical gap 116 is greater than 1 micron, and more preferably between 10 and 50 microns.

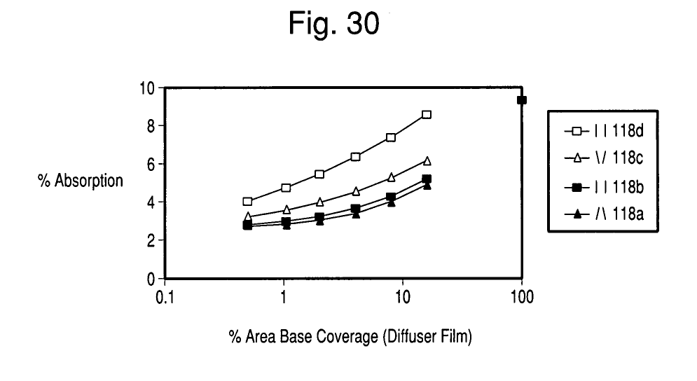

The absorption of the plate 100 depends on the composition and shape of the pillar structures. FIG. 29 illustrates some examples of pillar structures 118a through 118d of different shapes, and composition between the optical diffuser film 114 and the supporting substrate 112. FIG. 30 is a graph illustrating the optical plate absorption for the different pillar structures 118a through 118d as a function of the % area covered by the pillar structures contacting the surface of the optical diffuser film 114. In FIG. 29, the optical diffuser film 114 is made of polycarbonate with TOSPEARL™ scattering particles, while the supporting substrate is made of polycarbonate without scattering particles. A plurality of light sources 32 (CCFLs) is located near the plate 100 to provide light for the absorption calculations.

The pillar structures 118a through 118d have the following compositions and shape. Pillar structure 118a is made of polycarbonate with TOSPEARL™ scattering particles and has a truncated cone shape. Pillar structure 118b is made of polycarbonate with TOSPEARL™ scattering particles and has a cylindrical shape. Pillar structure 118c is made of polycarbonate without scattering particles and has a truncated cone shape. Pillar structure 118d is made of polycarbonate without scattering particles and has a cylindrical shape.

As can be seen from the graph of FIG. 30, the pillar structures including the TOSPEARL™ scattering particles provided the lowest optical plate absorption, with the truncated cone shape providing a lower absorption than the cylindrical shape.

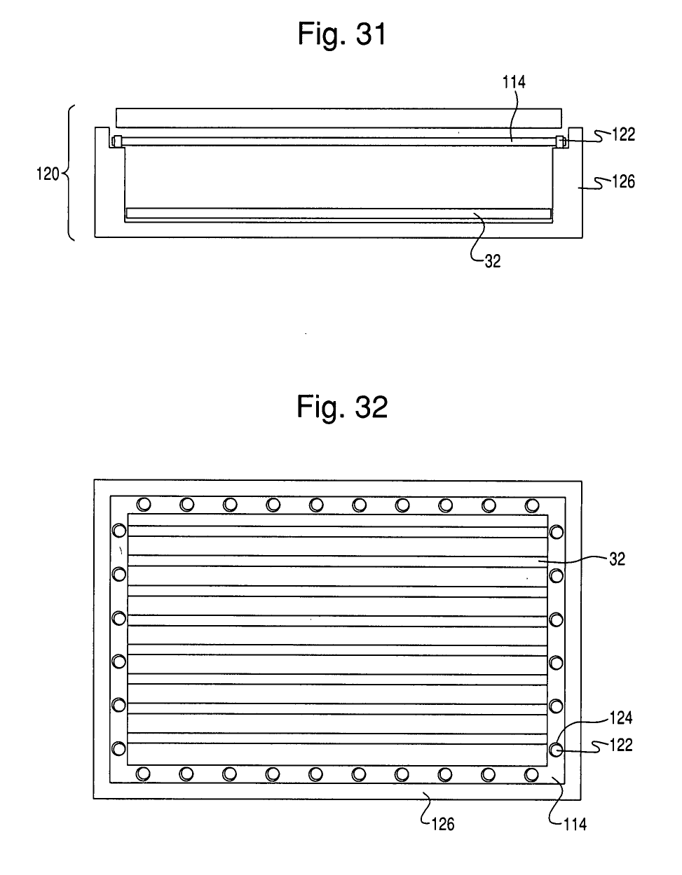

FIGS. 31 and 32 illustrate an optical assembly 120 with an optical diffuser film 114, but without the supporting substrate. The optical assembly 120 includes a light provider which comprises a plurality of light sources 32, such as CCFLs, that direct light toward the optical diffuser film 114. In the optical assembly 120, the relatively thin optical diffuser film 114 is supported by a frame 126. The light provider comprising a plurality of light sources 32 is arranged in a bottom portion of the frame 126.

The optical diffuser film 114 is attached to a top portion of the frame 126. In this regard, the optical assembly 120 may include a plurality of anchoring pins 122 arranged to attach the optical diffuser film 114 to the top portion of the frame 126, such as by being inserted into holes 124 in the optical diffuser film 114.

Preferably, the optical diffuser film 114 has a relatively low thermal coefficient of expansion in this embodiment. For example, the thermal coefficient of expansion may be less than 6.0×10⁻⁷ K⁻¹. The low thermal coefficient of expansion of the optical diffuser film 114 helps prevent buckling and sagging due to expansion/contraction of the film due to temperature changes.

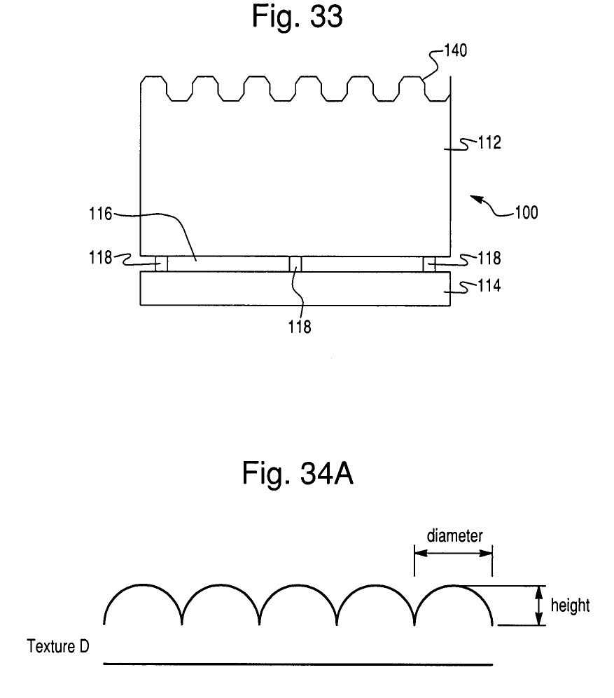

FIG. 33 illustrates an embodiment of the optical plate 100 where the surface 140 of the supporting substrate 112 is textured. The texture may be, for example, one of the textures A, B, or C as shown in FIGS. 9A, 10A and 10B, respectively, or texture D which is shown in FIGS. 34A and 34B. Texture D has hemispherical structures as shown in FIGS. 34A and 34B. The textures A, B, C, D are all regular in form. In practice the textures may be randomly modulated so that they are not regular in form, in order to reduce Moire effects. The optical plate 100 also includes a relatively thin optical diffuser film 114 as in earlier embodiments. The supporting substrate 112 and the optical diffuser film 114 are separated from each other so as to have a gap 116 there between by the means of pillar structures 118.

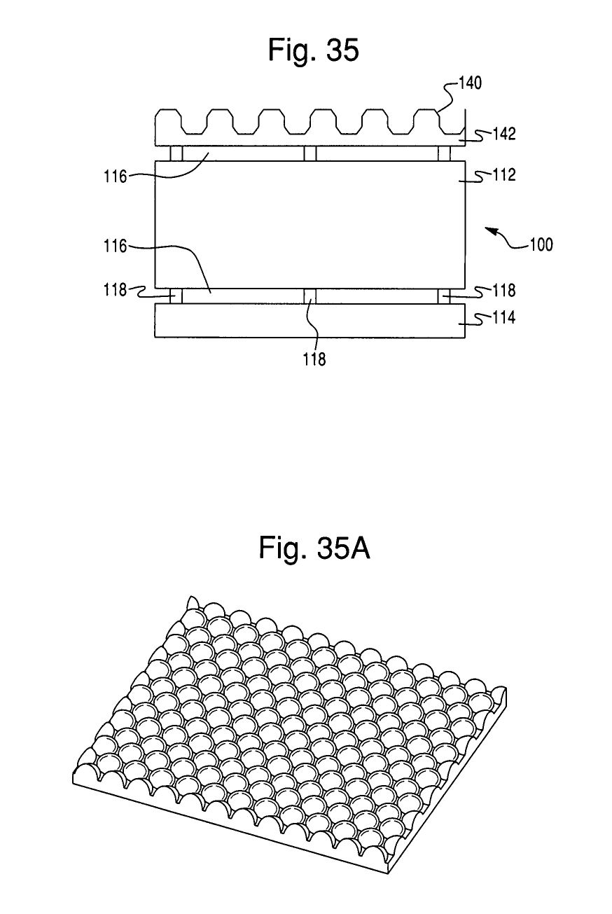

FIG. 35 illustrates another embodiment of the optical plate 100 including a plate texture layer 142 having a surface 140 which is textured. As with the embodiment of FIG. 33, the texture may be any one of textures A, B, C, or D, for example. In the embodiment of FIG. 35, the texture is incorporated in the plate texture layer 142 as compared to the supporting substrate 112 as in the embodiment of FIG. 33.

In the embodiment of FIG. 35, there are pillars 118 between the supporting substrate 112 and the plate texture layer 142 as well as between the supporting substrate 112 and the optical diffuser film 114 such that there is a gap 116 between the the supporting substrate 112 and the plate texture layer 142 as well as between the supporting substrate 112 and the optical diffuser film 114.

The total thickness of the structures in the embodiments of FIGS. 33 and 35 may be about the same, and in particular the combined thickness of the supporting substrate 112 and the plate texture layer 142 in FIG. 35 may be about the same as that of the supporting substrate 112 in FIG. 33.

### Optical Performance of Optical Plates

The optical properties, including absorption, hiding power, transmission, and haze, of various optical plates with relatively thin optical diffuser films was calculated, and compared with the properties of a thicker diffuser film, the two comparative examples DS and DS2. The results are shown in Table 6. The values in Table 6 were calculated using the validated optical model as discussed with respect to Table 1.

TABLE 6
Optical plates and calculated properties

| | | | | | | | | Plate | |
|---|---|---|---|---|---|---|---|---|---|
| | | | Clear | | | | | Only % | |
| | | | Substrate | Particle | Total | Total | | Bulb | Plate |
| Diffuser | Bottom | Top | Thickness | Concentration | Transmission | Reflection | Absorption | Hiding | Transmission |
| Sheet | Texture | Texture | (mm) | (pph) | (%) | (%) | (%) | Power | Haze % |
| 1. DS | Smooth | Smooth | NA | 0.5 | 58.03 | 32.89 | 9.08 | −0.5 ± 0.6 | 99.07 |
| 2. DS2 | Smooth | Smooth | NA | 0.125 | 79.12 | 15.6 | 5.28 | −28.7 ± 0.7 | 96.06 |
| 34. | Smooth | Smooth | 1.75 | 4.145 | 58.01 | 38.31 | 3.68 | −0.4 ± 0.8 | 99.10 |
| DPL- | | | | | | | | | |
| 1a | | | | | | | | | |
| 35. | Smooth | Smooth | 1.0 | 4.145 | 58.48 | 38.89 | 2.63 | −1.4 ± 0.7 | 99.09 |
| DPL- | | | | | | | | | |
| 2a | | | | | | | | | |
| 36. | Smooth | Smooth | 1.75 | 4.145 | 55.08 | 42.18 | 2.74 | −0.1 ± 1.1 | 99.04 |
| DPL- | | | | | | | | | |
| 1b | | | | | | | | | |
| 37. | Smooth | Smooth | 1.0 | 4.145 | 55.62 | 42.21 | 2.17 | −1.1 ± 0.5 | 99.05 |
| DPL- | | | | | | | | | |
| 2b | | | | | | | | | |
| 38. | Smooth | Texture B | 1.75 | 4.145 | 45.96 | 50.28 | 3.76 | −1.0 ± 1.9 | 98.80 |
| DPL- | | | | | | | | | |
| 3b | | | | | | | | | |
| 39. | Smooth | Texture B | 1.5 | 4.145 | 42.75 | 53.54 | 3.71 | −0.3 ± 0.7 | 98.78 |
| DPL- | | | | | | | | | |
| 4b | | | | | | | | | |
| 40. | Smooth | Texture D | 1.75 | 4.145 | 51.85 | 44.03 | 4.12 | −0.3 ± 0.6 | 98.78 |
| DPL- | | | | | | | | | |
| 5b | | | | | | | | | |
| 41. DPL- | Smooth | Texture D | 1.5 | 4.145 | 46.06 | 50.46 | 3.48 | 0.6 ± 0.6 | 98.61 |
| 6b | | | | | | | | | |

DS and DS2 are volumetric scattering diffuser sheets made of 2 mm thick polycarbonate as discussed above with respect to Table 1. Particle concentration is in parts per hundred (pph). The particles have a 2 micron diameter and are composed of TOSPEARL™ particles. Examples 34 through 41 were optical plates with an optical diffuser film separated by a gap of 10 microns from a supporting substrate.

The optical diffuser films of the optical plates were of polycarbonate and contained the particles, while the supporting substrates and plate texture layers were of polycarbonate without scattering particles. The designation “a” for optical plate indicates that the supporting substrate faces the light source, while the designation “b” indicates that optical diffuser film of the optical plates faces the light source. Thus, for samples 34 and 35, the supporting substrate faces the light source, while for samples 36-41, the optical diffuser film of the optical plates faces the light source. The Bottom Texture refers to the texture of the closest surface of the plate facing the light source, while the Top Texture refers to the surface of the plate furthest away from the light source. Textures B and D are sinusoidal wave and hemispherical, respectively, as discussed above.

The sample plates 34-41 have thicknesses for the optical diffuser films, supporting substrates and plate texture layer, if applicable, as follows: DPL-1: 1.75 mm thick supporting substrate and 0.25 mm thick optical diffuser film; DPL-2: 1.00 mm thick supporting substrate and 0.25 mm thick optical diffuser film; DPL-3: 1.75 mm thick supporting substrate and 0.25 mm thick optical diffuser film; and DPL-5: 1.75 mm thick supporting substrate and 0.25 mm thick optical diffuser film. The DPL-4 and DPL-6 samples also included a plate texture layer (See FIG. 35), and included a 0.25 mm plate texture layer; 1.50 mm thick supporting substrate and 0.25 mm thick optical diffuser film.

The calculated optical properties in table 6 show that reducing the thickness of the clear supporting substrate from 1.75 mm down to 1.0 mm leads to less absorption for respective optical plate DPL-1a relative to DPL-2a and DPL-1b relative to DPL-2b. The calculation results in table 6 also show that there is reduced absorption if the optical diffuser film of the optical plates faces the light source instead of the supporting substrate. This is demonstrated by the reduction in absorption for optical plate DPL-1b relative to DPL-1a and for optical plate DPL-2b relative to DPL-2a. The isolation of the texture from the supporting substrate DPL-6b as illustrated in FIG. 35, provides an additional reduction in absorption as demonstrated between optical plate DPL-6b relative to DPL-5b.

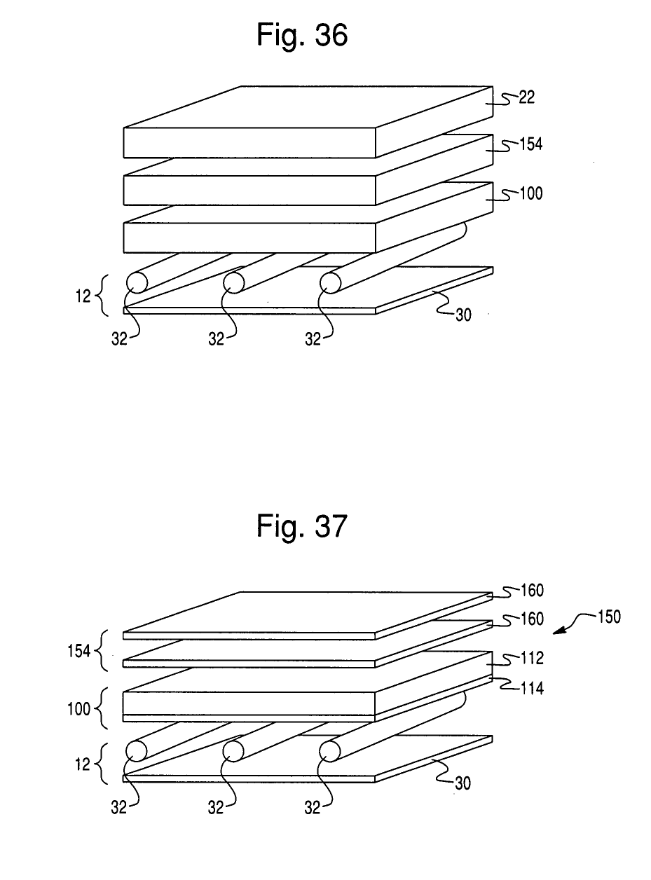

The optical plate of the embodiments of FIGS. 27, 28, 33 and 35, for example, as well optical display assembly of the embodiment of FIGS. 31 and 32 may be incorporated into various optical applications as desired. FIG. 36 illustrates a display assembly 150 according to an embodiment of the invention. The display assembly 150 includes a light provider 12 comprising a reflector 30 and a plurality of light sources 32 such as a CCFLs, and a liquid crystal 22. The display assembly also includes an optical plate 100, such as that shown in the embodiments of FIGS. 27, 28, 33 and 35, for example. The optical plate 100 may be oriented such that the diffuser optical film is towards the light provider 12 so that the diffuser optical film is between the light provider 12 and the support substrate, or such that the supporting substrate is towards the light provide so that the supporting substrate is between the light provider 12 and the optical diffuser film. Alternatively, the optical assembly of the embodiment of FIG. 29, where the frame supports the diffuser optical film may be incorporated into the display assembly 150.

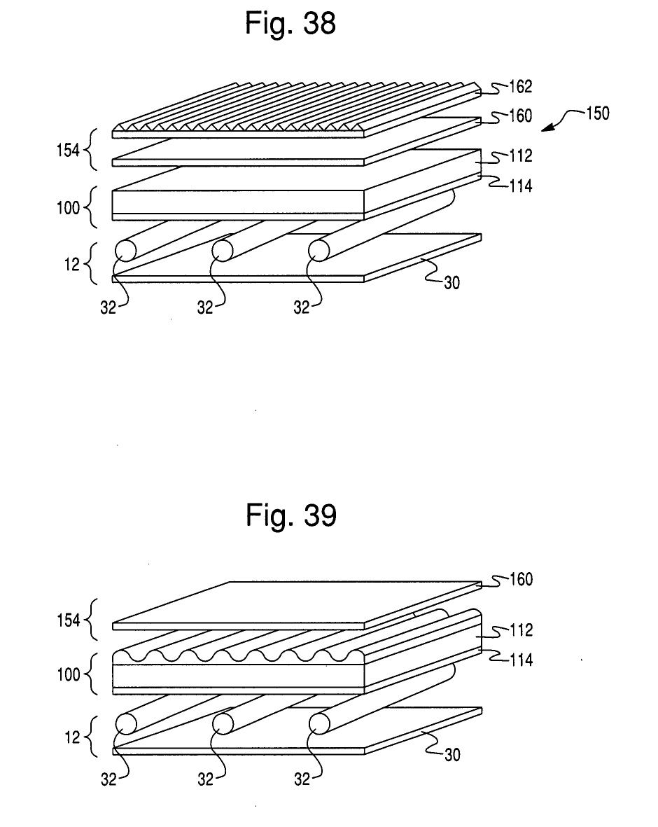

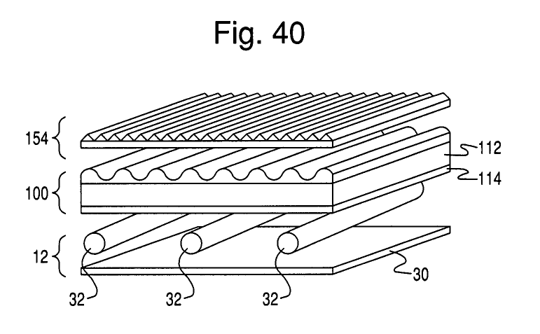

The display assembly 150 may also include a liquid crystal 152, and a film stack 154 between the liquid crystal 152 and the optical plate 100. The composition of the film stack will depend on the application, but in general may include one or more optical films such as light collimating diffuser films, prism films, light recycling polarizers, or lenticular films. FIGS. 36 to 40 illustrate various embodiments of the display assembly showing the portion of the assembly without the liquid crystal 152, with light collimating diffuser films 160, prism films 162, and light recycling polarizers 164.

### Optical Performance of Optical Display Assemblies With Optical Plates

The performance of various optical display assemblies including an optical plate and optical stack was calculated using the validated optical mode. The results are shown in Table 7 with samples 1 and 34-41 for comparison.

TABLE 7
Calculated Performance of display assemblies with optical plates

| | | +/− | % Bulb | | Horizontal | |
|---|---|---|---|---|---|---|
| | Luminance | Luminance | Hiding | +/− Hiding | View | Vertical View |
| Description | (cd/m²) | (StDev) | Power | (StDev) | (FWHM) | (FWHM) |
| 1. DS | 8,050 | 37 | −0.5 | 0.6 | 154.6 | 155.3 |
| 34. DPL-1a | 8,659 | 49 | −0.4 | 0.8 | 155.9 | 154.9 |
| 35. DPL-2a | 8,846 | 45 | −1.3 | 0.7 | 155.7 | 156.4 |
| 36. DPL-1b | 9,330 | 74 | −0.2 | 1.1 | 146.4 | 146.2 |
| 37. DPL-2b | 9,398 | 35 | −1.1 | 0.5 | 146.6 | 146.4 |
| 38. DPL-3b | 11,501 | 61 | −1.0 | 0.7 | 129.2 | 83.4 |
| 39. DPL-4b | 11,565 | 59 | −0.3 | 0.7 | 126.4 | 80.6 |
| 40. DPL-5b | 11,662 | 53 | −0.3 | 0.6 | 83.0 | 82.6 |
| 41. DPL-6b | 13,346 | 56 | 0.6 | 0.6 | 80.2 | 80.4 |
| 42. DS + DB | 10,112 | 51 | −0.5 | 0.4 | 82.0 | 81.6 |
| 43. DPL-1a + BD | 11,743 | 128 | −0.6 | 1.5 | 83.5 | 83.2 |
| 44. DPL-2a + BD | 12,049 | 127 | 0.9 | 1.5 | 82.3 | 83.3 |
| 45. DPL-1b + BD | 12,354 | 104 | 1.3 | 1.2 | 81.9 | 81.6 |
| 46. DPL-2b + BD | 12,737 | 149 | 0.2 | 1.7 | 81.2 | 81.2 |
| 47. DPL-3b + BD | 13,871 | 147 | 1.8 | 1.5 | 76.0 | 69.0 |
| 48. DPL-5b + BD | 13,293 | 125 | 1.2 | 1.3 | 75.5 | 76.0 |
| 49. DS + BD + BD | 11,166 | 114 | −0.4 | 0.4 | 70.8 | 69.3 |
| 50. DPL-1a + BD + BD | 14,057 | 93 | 0.5 | 0.9 | 69.7 | 69.9 |
| 51. DPL-2a + BD + BD | 15,014 | 100 | −0.8 | 0.9 | 69.3 | 69.7 |
| 52. DPL-1b + BD + BD | 14,679 | 160 | −0.6 | 1.5 | 69.1 | 68.5 |
| 53. DPL-2b + BD + BD | 15,292 | 118 | −1.0 | 1.1 | 69.0 | 68.6 |
| 54. DPL-3b + BD + BD | 15,152 | 148 | 0.1 | 1.4 | 64.5 | 61.8 |
| 55. DPL-3b + Prism | 17,888 | 137 | 1.9 | 1.1 | 96.7 | 53.5 |
| 56. DPL-5b + Prism | 14,988 | 168 | 2.1 | 1.6 | 100.9 | 67.3 |
| 57. DS + BD + Prism | 14,169 | 166 | −0.8 | 0.4 | 90.8 | 61.0 |
| 58. DPL-1a + BD + Prism | 17,734 | 150 | −1.0 | 1.2 | 86.9 | 60.5 |
| 59. DPL-2a + BD + Prism | 18,624 | 157 | 0.0 | 1.2 | 90.4 | 60.8 |
| 60. DPL-1b + BD + Prism | 17,810 | 151 | −0.9 | 1.2 | 88.0 | 61.1 |
| 61. DPL-2b + BD + Prism | 18,643 | 138 | −0.5 | 1.0 | 89.0 | 61.3 |
| 62. DPL-3b + BD + Prism | 16,648 | 100 | 0.6 | 0.8 | 87.7 | 62.3 |

The optical plates and orientation of the optical plates for DPL-1a, DPL-2a, DPL-1b, DPL-2b, DPL-3b DPL-4b, DPL-5b, and DPL-6b, are described above with respect to Table 6. For the samples with optical stacks, i.e., samples 43-62, the stacks were arranged above the optical plate (or diffuser sheets for samples 42, 49, and 57) on a side of the optical plate opposite from the light source. The description in Table 7 lists the order of the optical components from bottom to top above the optical plate. For example, for sample 67 the components are arranged with the diffuser plate at the bottom, then the light collimating diffuser film BD, and then the prism film Prism. BD is a light collimating diffuser film composed of 0.125 mm thick poly(ethylene terephthalate) with micro lens texture on a side facing viewer (detector), i.e., on a side away from the light provider. Prism is a horizontally oriented (prisms are parallel to the CCFL light sources) prism film composed of 0.125 mm thick poly(ethylene terephthalate) having a texture coating with an array of straight prisms having a 50 micron pitch and 25 micron height.

The calculated optical performances in table 7 show that reducing the thickness of the clear supporting substrate from 1.75 mm down to 1.0 mm in the optical plate leads to increase luminance for respective optical plate DPL-1a relative to DPL-2a and DPL-1b relative to DPL-2b in various display assemblies including the optical plate by itself and the optical plate with one microlens diffuser film; with two microlens diffuser film; and finally with one microlens diffuser film and one prism film. The calculation results in table 7 also show that there is increased luminance if the optical diffuser film of the optical plates faces the light source instead of the supporting substrate. This is demonstrated by the increase in luminance for optical plate DPL-1b relative to DPL-1a and for DPL-2b relative to DPL-2a. The isolation of the texture from the clear supporting substrate DPL-6b as illustrated in FIG. 35, provides an additional increase in luminance as demonstrated between optical plate DPL-6b relative to sample DPL-5b.

The performance of various optical display assemblies including an optical plate and optical stack was also measured using a 19 inch Westinghouse backlight module and a light detector. The Westinghouse backlight has a 25.3 mm bulb spacing between its CCFL bulbs. The distance between the bottom of the sample and the bulbs was 21.1 mm. The samples were arranged between the Westinghouse backlight and the sample. The arrangement of the samples is give in Table 8.

TABLE 8
Arrangement of samples

| | | Particle | |
|---|---|---|---|
| | | concentration in | |
| | | diffuser film | |
| Sample # | Optical plate or diffuser film | (Weight %) | Film Stack |
| 63 | 2.04 mm polycarbonate diffuser | 0.56 | none |
| | only | | |
| 64 | 2.04 mm polycarbonate diffuser | 0.56 | one microlens diffuser film |
| | only | | |
| 65 | 2.04 mm polycarbonate diffuser | 0.56 | two microlens diffuser films |
| | only | | |
| 66 | 2.04 mm polycarbonate diffuser | 0.56 | three microlens diffuser films |
| | only | | |
| 67 | 2.04 mm polycarbonate diffuser | 0.56 | one microlens diffuser film |
| | only | | and one prism film |
| 68 | 2.06 mm polycarbonate substrate | 5.6 | none |
| | and 0.26 mm diffuser film | | |
| 69 | 2.06 mm polycarbonate substrate | 5.6 | one microlens diffuser film |
| | and 0.26 mm diffuser film | | |
| 70 | 2.06 mm polycarbonate substrate | 5.6 | two microlens diffuser films |
| | and 0.26 mm diffuser film | | |
| 71 | 2.06 mm polycarbonate substrate | 5.6 | three microlens diffuser films |
| | and 0.26 mm diffuser film | | |
| 72 | 2.06 mm polycarbonate substrate | 5.6 | one microlens diffuser film |
| | and 0.26 mm diffuser film | | and one prism film |
| 73 | 2.06 mm polycarbonate substrate | 5.6 | none |
| | and 0.19 mm diffuser film | | |
| 74 | 2.06 mm polycarbonate substrate | 5.6 | one microlens diffuser film |
| | and 0.19 mm diffuser film | | |
| 75 | 2.06 mm polycarbonate substrate | 5.6 | two microlens diffuser films |
| | and 0.19 mm diffuser film | | |
| 76 | 2.06 mm polycarbonate substrate | 5.6 | three microlens diffuser films |
| | and 0.19 mm diffuser film | | |
| 77 | 2.06 mm polycarbonate substrate | 5.6 | one microlens diffuser film |
| | and 0.19 mm diffuser film | | and one prism film |
| 78 | 0.26 mm diffuser film only | 5.6 | none |
| 79 | 0.26 mm diffuser film only | 5.6 | one microlens diffuser film |
| 80 | 0.26 mm diffuser film only | 5.6 | two microlens diffuser films |
| 81 | 0.26 mm diffuser film only | 5.6 | three microlens diffuser films |
| 82 | 0.26 mm diffuser film only | 5.6 | one microlens diffuser film |
| | | | and one prism film |
| 83 | 0.19 mm diffuser film only | 5.6 | none |
| 84 | 0.19 mm diffuser film only | 5.6 | one microlens diffuser film |
| 85 | 0.19 mm diffuser film only | 5.6 | two microlens diffuser films |
| 86 | 0.19 mm diffuser film only | 5.6 | three microlens diffuser films |
| 87 | 0.19 mm diffuser film only | 5.6 | one microlens diffuser film |
| | | | and one prism film |
| 88 | 2.0 mm acrylic substrate and 0.19 mm | 5.6 | one microlens diffuser film |
| | diffuser film | | |
| 89 | 2.0 mm acrylic substrate and 0.19 mm | 5.6 | two microlens diffuser films |
| | diffuser film | | |
| 90 | 2.0 mm acrylic substrate and 0.19 mm | 5.6 | three microlens diffuser films |
| | diffuser film | | |
| 91 | 2.0 mm acrylic substrate and 0.19 mm | 5.6 | one microlens diffuser film |
| | diffuser film | | and one prism film |
| 92 | 2.04 mm polycarbonate diffuser | 0.56 | two microlens diffuser films |
| | only | | and light recyling polarizer |
| | | | and polarizer film |
| 93 | 2.04 mm polycarbonate diffuser | 0.56 | one microlens diffuser film |
| | only | | and one prism film and light |
| | | | recyling polarizer and |
| | | | polarizer film |
| 94 | 2.0 mm acrylic substrate and 0.19 mm | 5.6 | two microlens diffuser films |
| | diffuser film | | and light recyling polarizer |
| | | | and polarizer film |
| 95 | 2.0 mm acrylic substrate and 0.19 mm | 5.6 | one microlens diffuser film |
| | diffuser film | | and one prism film and light |
| | | | recyling polarizer and |
| | | | polarizer film |

Samples 63-67 and 92-93 included a relatively thick diffuser film made of optical grade polycarbonate as a comparison sample. The relatively thin diffuser films in samples 68-91 and 94-95 were also made of optical grade polycarbonate. The particles for all of the diffuser films were of TOSPEARL™ particles. All of the films and sheets in samples in listed in table 8 were made on an extrusion film and sheet line respectively. The transmission and transmission haze of the optical plates or diffuser films without an overlying film stack was measured and the results are shown in Table 9. As can be seen, the samples with a relatively thin diffuser film, samples 68, 73, 78, and 83, have a good transmission, while at the same time maintaining a relatively large transmission haze.

TABLE 9
Measured Transmission and Transmission Haze of
optical plate or diffuser film

| | Total | Transmission Haze |
|---|---|---|
| Sample # | Transmission (%) | (%) |
| 63 | 57.6 | 99.1 |
| 68 | 60.4 | 99.3 |
| 73 | 64.2 | 99.2 |
| 78 | 66.1 | 99.3 |
| 83 | 70.8 | 99.2 |

The results of the luminance measurements for the samples with an overlying film stack are shown in Table 10. The luminance gain is relative to the comparison samples with a relatively thick diffuser film, i.e. samples 64-67 and 92-93, where samples having the same stack are compared. As can be seen, the results in Table 10 show a positive luminance gain for all of the samples with a relatively thin diffuser film as compared to the thicker diffuser film. The gain increases as the number of collimating films (microlens diffuser films) is increased. The gain is greatest for those samples with a prism film.

TABLE 10
(Measured 13 point and 5 point luminance and luminance
gain for assemblies with film stack)

| | 13 pt | | | |
|---|---|---|---|---|
| | luminance | 5 pt luminance | Luminance | % Bulb Hiding |
| Sample # | (Cd/m2) | (Cd/m2) | Gain | Power |
| 64 | 6,460 | 6,584 | 0.0 | −0.7 |
| 65 | 7,087 | 7,272 | 0.0 | −0.8 |
| 66 | 7,103 | 7,325 | 0.0 | −0.8 |
| 67 | 8,874 | 9,185 | 0.0 | −0.5 |
| 69 | 6,495 | | 0.5 | −0.7 |
| 70 | 7,218 | | 1.8 | −0.9 |
| 71 | 7,313 | | 3.0 | −1.1 |
| 72 | 9,198 | | 3.7 | −0.9 |
| 74 | 6,591 | | 2.0 | −0.5 |
| 75 | 7,328 | | 3.4 | −0.7 |
| 76 | 7,392 | | 4.1 | −1.1 |
| 77 | 9,288 | | 4.7 | −0.5 |
| 79 | | 6,871 | 4.4 | −1.7 |
| 80 | | 7,692 | 5.8 | −1.6 |
| 81 | | 7,792 | 6.4 | −1.4 |
| 82 | | 9,800 | 6.7 | −1.1 |
| 84 | | 6,912 | 5.0 | −1.5 |
| 85 | | 7,711 | 6.0 | −1.4 |
| 86 | | 7,833 | 6.9 | −1.2 |
| 87 | | 9,822 | 6.9 | −1.1 |
| 88 | 6,675 | | 3.3 | −1.1 |
| 89 | 7,423 | | 4.7 | −1.3 |
| 90 | 7,526 | | 6.0 | −1.2 |
| 91 | 9,485 | | 6.9 | −1.1 |
| 92 | 4,509 | | 0.0 | −1.2 |
| 93 | 5,080 | | 0.0 | −1.3 |
| 94 | 4,764 | | 5.6 | −1.4 |
| 95 | 5,434 | | 7.0 | −1.8 |

While the invention has been described with reference to several embodiments thereof, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. An optical plate comprising:
a supporting substrate; and
an optical diffuser film having a density of light scattering particles to provide light diffusion and having a surface facing the supporting substrate, wherein a first portion of the surface facing the supporting substrate contacts the supporting substrate and there exists a gap between a second portion of the surface facing the supporting substrate and the supporting substrate, wherein the ratio of the area of the first portion to the second portion is less than 10%.

2. The optical plate of claim 1, wherein the ratio of the area of the first portion to the second portion is less than 3%.

3. The optical plate of claim 1, wherein the ratio of the area of the first portion to the second portion is less than 1%.

4. The optical plate of claim 1, wherein the supporting substrate has an absorption less than 1.5%.

5. The optical plate of claim 1, wherein the optical plate when illuminated is characterized by an absorption of less than 10% and an absolute hiding power of less than 10%.

6. The optical plate of claim 5, wherein the optical plate when illuminated is characterized by an absorption of less than 7% and an absolute hiding power of less than 7%.

7. The optical plate of claim 6, wherein the optical plate when illuminated is characterized by an absorption of less than 4% and an absolute hiding power of less than 4%.

8. The optical plate of claim 1, wherein the optical diffuser film has a density of light scattering particles of greater than 2 weight percent.

9. An optical display assembly comprising:
a light provider comprising a plurality of light sources; and
an optical plate comprising:
a supporting substrate; and
an optical diffuser film having a density of light scattering particles to provide light diffusion of light from the light provider and having a surface facing the supporting substrate, wherein a first portion of the surface facing the supporting substrate contacts the supporting substrate and there exists a gap between a second portion of the surface facing the supporting substrate and the supporting substrate, wherein the ratio of the area of the first portion to the second portion is less than 10%.

10. The optical display assembly of claim 9, wherein the supporting substrate is arranged between the optical diffuser film and the light provider.

11. The optical display assembly of claim 9, wherein the optical diffuser film is arranged between the supporting substrate and the light provider.

12. The optical display assembly of claim 9, further comprising:
a first light collimating diffuser film arranged above the optical plate.

13. The optical display assembly of claim 12, further comprising:
a second light collimating diffuser film arranged above the first light collimating diffuser film.

14. The optical display assembly of claim 13, further comprising:
a third light collimating diffuser film arranged above the second light collimating diffuser film.

15. The optical display assembly of claim 9, further comprising:
a light collimating diffuser film arranged above the optical plate; and
a prism film arranged above the light collimating diffuser film and the optical plate.

16. The optical display assembly of claim 9, further comprising:
a first prism film arranged above the optical plate; and
a second prism film arranged above the first prism film and the optical plate.

17. The optical display assembly of claim 16, wherein the first prism film has a plurality of prism structures oriented in a first direction and the second prism film has a plurality of prism structures oriented in a second direction, the first direction being perpendicular to the second direction.

18. The optical display assembly of claim 9, further comprising:
a light recycling polarizer arranged above the optical plate.

19. The optical display assembly of claim 12, further comprising:
a light recycling polarizer arranged above the optical plate.

20. The optical display assembly of claim 13, further comprising:
a light recycling polarizer arranged above the optical plate.

21. The optical display assembly of claim 14, further comprising:
a light recycling polarizer arranged above the optical plate.

22. The optical display assembly of claim 15, further comprising:
a light recycling polarizer arranged above the optical plate.

23. The optical display assembly of claim 16, further comprising:
a light recycling polarizer arranged above the optical plate.

24. The optical display assembly of claim 17, further comprising:
a light recycling polarizer arranged above the optical plate.

25. The optical display assembly of claim 9, further comprising:
a liquid crystal arranged above the optical plate.

26. The optical display assembly of claim 9, further comprising:
a lenticular film arranged above the optical plate.

27. The optical display assembly of claim 26, further comprising:
a light recycling polarizer arranged above the optical plate.

28. An optical plate comprising:
a supporting substrate;
an optical diffuser film having a density of light scattering particles to provide light diffusion and having a surface facing the supporting substrate and a gap between the optical diffuser film and supporting substrate, the surface having a total area above the supporting substrate; and
a plurality of pillar structures between and contacting both the optical diffuser film and the supporting substrate, the plurality of pillar structures contacting the optical diffuser film over a first area of the surface facing the supporting substrate, wherein the ratio of the first area to the total area is less than 10%.

29. The optical plate of claim 28, wherein the pillar structures are formed of the same material as the optical diffuser film.

30. The optical plate of claim 28, wherein the ratio of the first area to the total area is less than 3%.

31. The optical plate of claim 28, wherein the ratio of the first area to the total area is less than 1%.

32. The optical plate of claim 10, wherein the supporting substrate has an absorption less than 1.5%.

33. The optical plate of claim 28, wherein the optical plate when illuminated is characterized by an absorption of less than 10% and an absolute hiding power of less than 10%.

34. The optical plate of claim 33, wherein the optical plate when illuminated is characterized by an absorption of less than 7% and an absolute hiding power of less than 7%.

35. The optical plate of claim 34, wherein the optical plate when illuminated is characterized by an absorption of less than 4% and an absolute hiding power of less than 4%.

36. The optical plate of claim 28, wherein the optical diffuser film has a density of light scattering particles of greater than 2 weight percent.

37. An optical display assembly comprising:
a light provider comprising a plurality of light sources; and
an optical plate comprising:
a supporting substrate;
an optical diffuser film having a density of light scattering particles to provide light diffusion of light from the light provider and having a surface facing the supporting substrate and a gap between the diffuser film and supporting substrate, the surface having a total area above the supporting substrate; and
a plurality of pillar structures between and contacting both the optical diffuser film and the supporting substrate, the plurality of pillar structures contacting the optical diffuser film over a first area of the surface facing the supporting substrate, wherein the ratio of the first area to the total area is less than 10%.

38. The optical display assembly of claim 37, wherein the pillar structures are formed of the same material as the optical diffuser film.

39. The optical display assembly of claim 37, wherein the supporting substrate is arranged between the optical diffuser film and the light provider.

40. The optical display assembly of claim 37, wherein the optical diffuser film is arranged between the supporting substrate and the light provider.

41. The optical display assembly of claim 37, further comprising:
a first light collimating diffuser film arranged above the optical plate.

42. The optical display assembly of claim 41, further comprising:
a second light collimating diffuser film arranged above the first light collimating diffuser film.

43. The optical display assembly of claim 42, further comprising:
a third light collimating diffuser film arranged above the second light collimating diffuser film.

44. The optical display assembly of claim 37, further comprising:
a light collimating diffuser film arranged above the optical plate; and
a prism film arranged above the light collimating diffuser film and the optical plate.

45. The optical display assembly of claim 37, further comprising:
a first prism film arranged above the optical plate; and
a second prism film arranged above the first prism film and the optical plate.

46. The optical display assembly of claim 45, wherein the first prism film has a plurality of prism structures oriented in a first direction and the second prism film has a plurality of prism structures oriented in a second direction, the first direction being perpendicular to the second direction.

47. The optical display assembly of claim 37, further comprising:
a light recycling polarizer arranged above the optical plate.

48. The optical display assembly of claim 40, further comprising:
a light recycling polarizer arranged above the optical plate.

49. The optical display assembly of claim 41, further comprising:
a light recycling polarizer arranged above the optical plate.

50. The optical display assembly of claim 42, further comprising:
a light recycling polarizer arranged above the optical plate.

51. The optical display assembly of claim 43, further comprising:
a light recycling polarizer arranged above the optical plate.

52. The optical display assembly of claim 44, further comprising:
a light recycling polarizer arranged above the optical plate.

53. The optical display assembly of claim 39, further comprising:
a light recycling polarizer arranged above the optical plate.

54. The optical display assembly of claim 46, further comprising:
a light recycling polarizer arranged above the optical plate.

55. The optical display assembly of claim 37, further comprising:
a liquid crystal arranged above the optical plate.

56. The optical display assembly of claim 37, further comprising:
a lenticular film arranged above the optical plate.

57. The optical display assembly of claim 56, further comprising:
a light recycling polarizer arranged above the optical plate.

58. An optical assembly comprising:
a light provider comprising a plurality of light sources;
an optical diffuser film over the light provider and arranged to receive light from the light provider, wherein a gap exists between the light provider and the optical diffuser film, the optical diffuser film having a density of light scattering particles to provide light diffusion.

59. The optical assembly of claim 58, further comprising:
a frame, wherein the light provider is arranged in a bottom portion of the frame, and the optical diffuser film is attached to a top portion of the frame.

60. The optical assembly of claim 59, further comprising:
a plurality of anchoring pins attaching the optical diffuser film to the top portion of the frame.

61. The optical assembly of claim 59, wherein the optical diffuser film has a thermal coefficient of expansion of less than 6.0×10⁻⁷ K⁻¹.

62. The optical assembly of claim 59, wherein the optical diffuser film when illuminated by the light provider is characterized by an absorption of less than 10% and an absolute hiding power of less than 10%.

63. The optical assembly of claim 62, wherein the optical diffuser film when illuminated by the light provider is characterized by an absorption of less than 7% and an absolute hiding power of less than 7%.

64. The optical assembly of claim 63, wherein the optical diffuser film when illuminated by the light provider is characterized by an absorption of less than 4% and an absolute hiding power of less than 4%.

65. The optical assembly of claim 59, wherein the optical diffuser film has a density of light scattering particles of greater than 2 weight percent.

66. The optical assembly of claim 58, further comprising:
a first light collimating diffuser film arranged above the optical diffuser film.

67. The optical assembly of claim 66, further comprising:
a second light collimating diffuser film arranged above the first light collimating diffuser film.

68. The optical assembly of claim 67, further comprising:
a third light collimating diffuser film arranged above the second light collimating diffuser film.

69. The optical assembly of claim 58, further comprising:
a light collimating diffuser film arranged above the optical diffuser film; and
a prism film arranged above the light collimating diffuser film and the optical diffuser film.

70. The optical assembly of claim 58, further comprising:
a first prism film arranged above the optical diffuser film; and
a second prism film arranged above the first prism film and the optical diffuser film.

71. The optical assembly of claim 70, wherein the first prism film has a plurality of prism structures oriented in a first direction and the second prism film has a plurality of prism structures oriented in a second direction, the first direction being perpendicular to the second direction.

72. The optical assembly of claim 58, further comprising:
a light recycling polarizer arranged above the optical diffuser film.

73. The optical assembly of claim 66, further comprising:
a light recycling polarizer arranged above the optical diffuser film.

74. The optical assembly of claim 67, further comprising:
a light recycling polarizer arranged above the optical diffuser film.

75. The optical assembly of claim 68, further comprising:
a light recycling polarizer arranged above the optical diffuser film.

76. The optical assembly of claim 69, further comprising:
a light recycling polarizer arranged above the optical diffuser film.

77. The optical assembly of claim 70, further comprising:
a light recycling polarizer arranged above the optical diffuser film.

78. The optical assembly of claim 71, further comprising:
a light recycling polarizer arranged above the optical diffuser film.

79. A method of forming an optical plate comprising:
spray coating an optical diffuser film on a supporting substrate,
the optical diffuser film having a density of light scattering particles to provide light diffusion and having a surface facing the supporting substrate, wherein a first portion of the surface facing the supporting substrate contacts the supporting substrate and there exists a gap between a second portion of the surface facing the supporting substrate and the supporting substrate, wherein the ratio of the area of the first portion to the second portion is less than 10%.

80. An optical plate formed according to the method of claim 79.
